(19) United States
(12) Patent Application Publication
(10) Pub. No.: US 2021/0043941 A1
(43) Pub. Date: Feb. 11, 2021

(54) BATTERY

(71) Applicant: MURATA MANUFACTURING CO., LTD., Kyoto (JP)

(72) Inventors: Hiroshi HORIUCHI, Kyoto (JP); Nobuyuki IWANE, Kyoto (JP)

(21) Appl. No.: 17/078,934

(22) Filed: Oct. 23, 2020

Related U.S. Application Data
(63) Continuation of application No. PCT/JP2019/018001, filed on Apr. 26, 2019.

(30) Foreign Application Priority Data
Apr. 27, 2018 (JP) 2018-087815

(51) Int. Cl. H01M 4/66; H01M 10/0565; H01M 4/13

(52) U.S. Cl. CPC H01M 4/661; H01M 4/13; H01M 10/0565

(57) ABSTRACT

A battery includes a positive electrode that includes a positive electrode current collector and a positive electrode active material layer provided on the positive electrode current collector and has a positive electrode current collector exposed portion at which the positive electrode current collector is exposed; a negative electrode that includes a negative electrode current collector and a negative electrode active material layer provided on the negative electrode current collector and has a negative electrode current collector exposed portion at which the negative electrode current collector is exposed; a separator provided between the positive electrode and the negative electrode; and an intermediate layer that is provided between the separator and at least one of the positive and negative electrodes and includes at least one of a fluororesin and a grain.

### CROSS REFERENCE TO RELATED APPLICATIONS

The present application is a continuation of PCT patent application no. PCT/JP2019/018001, filed on Apr. 26, 2019, which claims priority to Japanese patent application no. JP2018-087815 filed on Apr. 27, 2018, the entire contents of which are being incorporated herein by reference.

### BACKGROUND

The present technology generally relates to a battery.

In recent years, a technology to use binders with low melting points as binders for electrodes has been investigated in order to improve battery characteristics.

### SUMMARY

The present technology generally relates to a battery.

An object of the present technology is to provide a battery which can be improved in safety.

In order to solve the above problems, a battery is provided according to an embodiment of the present technology. The battery includes a positive electrode that includes a positive electrode current collector and a positive electrode active material layer provided on the positive electrode current collector and has a positive electrode current collector exposed portion at which the positive electrode current collector is exposed; a negative electrode that includes a negative electrode current collector and a negative electrode active material layer provided on the negative electrode current collector and has a negative electrode current collector exposed portion at which the negative electrode current collector is exposed; a separator provided between the positive electrode and the negative electrode; and an intermediate layer that is provided between the separator and at least one of the positive electrode and the negative electrode and includes at least one of a fluororesin and a grain and in which the positive electrode, the negative electrode, and the separator are stacked, and the positive electrode current collector exposed portion and the negative electrode current collector exposed portion face each other with the separator interposed therebetween, the positive electrode active material layer contains a fluorine-based binder having a melting point of 166° C. or less and a conductive agent, a content of the fluorine-based binder in the positive electrode active material layer is from 0.5% by mass to 2.8% by mass, and a content of the conductive agent in the positive electrode active material layer is from 0.3% by mass to 2.8% by mass.

According to at least an embodiment of the present technology, the safety of a battery can be improved. It should be understood that the effects described here are not necessarily limited and may be any one of the effects described in the present invention or an effect different from them.

### BRIEF DESCRIPTION OF THE FIGURES

FIG. 1 is an exploded perspective view of a non-aqueous electrolyte secondary battery according to an embodiment of the present technology.

FIG. 2 is a sectional view taken along the line II-II in FIG. 1.

FIG. 3 is an enlarged sectional view of a part of FIG. 2.

FIG. 4 is a sectional view of a non-aqueous electrolyte secondary battery according to an embodiment of the present technology.

FIG. 5 is a sectional view of a wound electrode body cut in a direction perpendicular to a height direction according to an embodiment of the present technology.

FIG. 6 is a sectional view of a wound electrode body according to an embodiment of the present technology.

FIG. 7 is a sectional view of a wound electrode body according to an embodiment of the present technology.

FIG. 8 is a block diagram of an electronic device as an application example according to an embodiment of the present technology.

FIG. 9 is a sectional view of a wound electrode body according to an embodiment of the present technology.

### DETAILED DESCRIPTION

As described herein, the present disclosure will be described based on examples with reference to the drawings, but the present disclosure is not to be considered limited to the examples, and various numerical values and materials in the examples are considered by way of example.

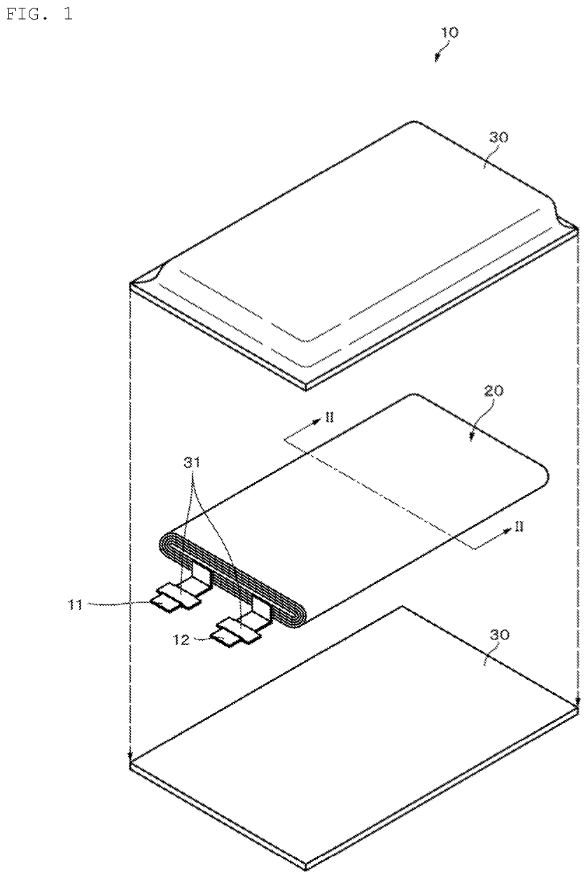

As illustrated in FIG. 1, a non-aqueous electrolyte secondary battery (hereinafter simply referred to as “battery”) 10 according to a first embodiment of the present invention is a so-called laminate film type battery, miniaturization, weight saving, and thinning of the battery 10 are possible, and a flat wound electrode body 20 to which a positive electrode lead 11 and a negative electrode lead 12 are attached is housed inside a film-like exterior material 30 in the battery 10. The battery 10 is, for example, a so-called lithium ion secondary battery in which the capacitance of the negative electrode is represented by a capacitance component due to storage and release of lithium (Li) that is an electrode reactant.

The positive electrode lead 11 and the negative electrode lead 12 are both led out, for example, in the same direction from the inside to the outside of the exterior material 30. The positive electrode lead 11 and the negative electrode lead 12 are each formed of a metal material such as aluminum (Al), copper (Cu), nickel (Ni), or stainless steel and each have a thin plate shape or a mesh shape.

The exterior material 30 is formed of, for example, a laminate film exhibiting flexibility. The exterior material 30 has, for example, a configuration in which a heat-sealing resin layer, a metal layer, and a surface protective layer are sequentially laminated. The surface on the heat-sealing resin layer side is the surface on the side on which the wound electrode body 20 is housed. Examples of the material for this heat-sealing resin layer include polypropylene (PP) and polyethylene (PE). Examples of the material for the metal layer include aluminum. Examples of the material for the surface protective layer include nylon (Ny). Specifically, for example, the exterior material 30 is formed of, for example, a rectangular aluminum laminate film in which a nylon film, an aluminum foil, and a polyethylene film are bonded to each other in this order. The exterior material 30 is arranged so that, for example, the heat-sealing resin layer side and the wound electrode body 20 face each other, and the respective outer edge portions are in close contact with each other by sealing or an adhesive. A close contact film 31 is inserted between the exterior material 30 and the positive electrode lead 11 and between the exterior material 30 and the negative electrode lead 12 to prevent intrusion of outside air. The close contact film 31 is formed of a material exhibiting close contact property to the positive electrode lead 11 and the negative electrode lead 12, for example, a polyolefin resin such as polyethylene, polypropylene, modified polyethylene, or modified polypropylene.

The exterior material 30 may be formed of a laminate film having another structure, a polymer film such as polypropylene, or a metal film instead of the above-described laminate film. Alternatively, a laminate film in which a polymer film is laminated on one surface or both surfaces of an aluminum film as a core material may be used.

As the exterior material 30, one further including a colored layer and/or one containing a coloring material in at least one layer selected from the heat-sealing resin layer or the surface protective layer may be used from the viewpoint of aesthetic appearance. In a case in which an adhesive layer is provided at least between the heat-sealing resin layer and the metal layer or between the surface protective layer and the metal layer, the adhesive layer may contain a coloring material.

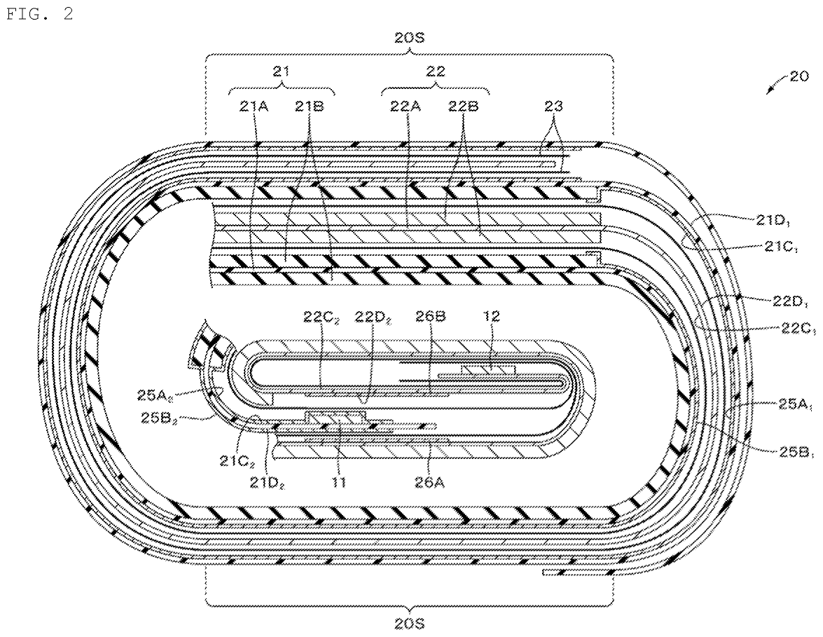

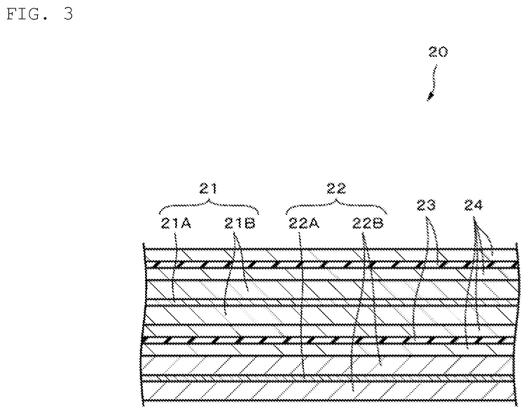

As illustrated in FIGS. 2 and 3, the wound electrode body 20 as a battery element is obtained by stacking a strip-like positive electrode 21 and a strip-like negative electrode 22 with a strip-like separator 23 and an electrolyte layer 24 interposed therebetween and winding these in a flat and spiral shape, and the outermost peripheral portion thereof is protected by a protective tape (not illustrated). In FIG. 2, in order to facilitate understanding of the winding structure of the wound electrode body 20, the illustration of the electrolyte layer 24 is omitted and a gap is provided between the respective constituent members of the wound electrode body 20.

Hereinafter, the positive electrode 21, negative electrode 22, separator 23, and electrolyte layer 24 which constitute the wound electrode body 20 will be sequentially described.

The positive electrode 21 includes a positive electrode current collector 21A and a positive electrode active material layer 21B provided on both surfaces of the positive electrode current collector 21A. The positive electrode current collector 21A is formed of, for example, a metal foil such as an aluminum foil, a nickel foil, or a stainless foil. The positive electrode active material layer 21B includes, for example, a positive electrode active material capable of storing and releasing lithium that is an electrode reactant, a binder, and a conductive agent.

As the positive electrode active material capable of storing and releasing lithium, a lithium-containing compound, for example, lithium oxide, lithium phosphorus oxide, lithium sulfide, or an intercalation compound containing lithium is suitable, and two or more of these may be used in mixture. In order to increase the energy density, a lithium-containing compound which contains lithium, a transition metal element, and oxygen (O) is preferable. Examples of such a lithium-containing compound include a lithium composite oxide having a layered rock salt type structure represented by Formula (A) and a lithium composite phosphate having an olivine type structure represented by Formula (B). The lithium-containing compound is more preferably a compound containing at least one selected from the group consisting of cobalt (Co), nickel, manganese (Mn), and iron (Fe) as a transition metal element. Examples of such a lithium-containing compound include a lithium composite oxide having a layered rock salt type structure represented by Formula (C), Formula (D), or Formula (E), a lithium composite oxide having a spinel type structure represented by Formula (F), or a lithium composite phosphate having an olivine type structure represented by Formula (G). Specific examples thereof include LiNi_{0.50}Co_{0.20}Mn_{0.30}O₂, LiaCoO₂(a≈1), Li_{b}NiO₂(b≈1), Li_{c1}Ni_{c2}Co_{1-c2}O₂(c1≈1, 0<c2<1), Li_{d}Mn₂O₄(d≈1), or LiₑFePO₄(e≈1).

LiₚNi_{(1-g-r)}Mn_{q}M1ᵣO_{(2-y)}X_{z} (A)

(In Formula (A), M1 represents at least one selected from the elements belonging to the groups 2 to 15 except nickel and manganese. X represents at least one among the elements belonging to the group 16 and the elements belonging to the group 17 other than oxygen. p, q, y, and z are values within ranges of 0≤p≤1.5, 0≤q≤1.0, 0≤r≤1.0, −0.10≤y≤0.20, and 0≤z≤0.2.)

LiₐM2_{b}PO₄ (B)

(In Formula (B), M2 represents at least one selected from the elements belonging to the groups 2 to 15. a and b are values within ranges of 0≤a≤2.0 and 0.5≤b≤2.0.)

LiᵣMn_{(1-g-h)}Ni_{g}M3_{b}O₍₂₋ⱼ₎Fₖ (C)

(In Formula (C), M3 represents at least one selected from the group consisting of cobalt, magnesium (Mg), aluminum, boron (B), titanium (Ti), vanadium (V), chromium (Cr), iron, copper, zinc (Zn), zirconium (Zr), molybdenum (Mo), tin (Sn), calcium (Ca), strontium (Sr), and tungsten (W). f, g, h, j, and k are values within ranges of 0.8≤f≤1.2, 0≤g≤0.5, 0≤h≤0.5, g+h<1, −0.1≤j≤0.2, and 0≤k≤0.1. The composition of lithium differs depending on the state of charge and discharge, and the value of f represents a value in the fully discharged state.)

LiₘNi₍ᵢ₋ₙ₎M4ₙO₍₂₋ₚ₎F_{q} (D)

(In Formula (D), M4 represents at least one selected from the group consisting of cobalt, manganese, magnesium, aluminum, boron, titanium, vanadium, chromium, iron, copper, zinc, molybdenum, tin, calcium, strontium, and tungsten. m, n, p, and q are values within ranges of 0.8≤m≤1.2, 0.005≤n≤0.5, −0.1≤p≤0.2, and 0≤q≤0.1. The composition of lithium differs depending on the state of charge and discharge, and the value of m represents a value in the fully discharged state.)

LiᵣCo₍₁₋ₛ₎M5ₛO₍₂₋ₜ₎Fᵤ (E)

(In Formula (E), M5 represents at least one selected from the group consisting of nickel, manganese, magnesium, aluminum, boron, titanium, vanadium, chromium, iron, copper, zinc, molybdenum, tin, calcium, strontium, and tungsten. r, s, t, and u are values within ranges of 0.8≤r≤1.2, 0≤s<0.5, −0.1≤t≤0.2, and 0≤u≤0.1. The composition of lithium differs depending on the state of charge and discharge, and the value of r represents a value in the fully discharged state.)

LiᵥMn_{2-w}M6_{w}OₓF_{y} (F)

(In Formula (F), M6 represents at least one selected from the group consisting of cobalt, nickel, magnesium, aluminum, boron, titanium, vanadium, chromium, iron, copper, zinc, molybdenum, tin, calcium, strontium, and tungsten. v, w, x, and y are values within ranges of 0.9≤v≤1.1, 0≤w≤0.6, 3.7≤x≤4.1, and 0≤y≤0.1. The composition of lithium differs depending on the state of charge and discharge, and the value of v represents a value in the fully discharged state.)

Li_{z}M7PO₄ (G)

(In Formula (G), M7 represents at least one selected from the group consisting of cobalt, manganese, iron, nickel, magnesium, aluminum, boron, titanium, vanadium, niobium (Nb), copper, zinc, molybdenum, calcium, strontium, tungsten, and zirconium. z is a value within a range of 0.9≤z≤1.1. The composition of lithium differs depending on the state of charge and discharge, and the value of z represents a value in the fully discharged state.)

Examples of the positive electrode active material capable of storing and releasing lithium also include inorganic compounds which do not contain lithium such as MnO₂, V₂O₅, V₆O₁₃, NiS, and MoS in addition to these.

The positive electrode active material capable of storing and releasing lithium may be one other than the above. Two or more of the positive electrode active materials exemplified above may be mixed in any combination.

The binder includes a fluorine-based binder having a melting point of 166° C. or less. When the melting point of the fluorine-based binder is 166° C. or less, the affinity between the fluorine-based binder and the positive electrode active material grains is improved, the positive electrode active material grains can be favorably covered with the fluorine-based binder, and thus the reaction between the positive electrode active material grains and the electrolytic solution can be suppressed. Hence, the swelling of the battery 10 due to gas generation can be suppressed. By favorably covering the positive electrode active material grains with the fluorine-based binder, it is possible to improve the thermal stability of the positive electrode 21, and thus it is also possible to improve the safety (for example, the short circuit-based safety evaluated by the nail penetration test and the heating-based safety evaluated by the heating test) of the battery 10. The lower limit value of the melting point of the fluorine-based binder is not particularly limited but is, for example, 150° C. or more.

The melting point of the fluorine-based binder is measured, for example, as follows. First, the positive electrode 21 is taken out from the battery 10, washed with dimethyl carbonate (DMC), and dried, then the positive electrode current collector 21A is removed therefrom, and the rest is heated and stirred in a suitable dispersion medium (for example, N-methylpyrrolidone) to dissolve the binder in the dispersion medium. Thereafter, the positive electrode active material is removed from the solution by centrifugation, the supernatant liquid is filtered, and then the residue is subjected to evaporation to dryness or reprecipitation in water, whereby the binder can be taken out.

Next, a sample in an amount of several to several tens of mg is heated at a rate of temperature rise of 1° C./min to 10° C./min using DSC (differential scanning calorimeter, for example, Rigaku Thermoplus DSC8230 manufactured by Rigaku Corporation), and the temperature at which the maximum endothermic energy amount is attained is taken as the melting point of the fluorine-based binder. In the present invention, the temperature at which the polymer becomes fluid by heating and temperature rise is defined as the melting point.

The fluorine-based binder is, for example, polyvinylidene fluoride (PVdF). As polyvinylidene fluoride, it is preferable to use a homopolymer containing vinylidene fluoride (VdF) as a monomer. As polyvinylidene fluoride, it is also possible to use a copolymer containing vinylidene fluoride (VdF) as a monomer, but polyvinylidene fluoride that is a copolymer easily swells and dissolves in the electrolytic solution and has weak binding force, and thus the characteristics of the positive electrode 21 may be deteriorated. As the polyvinylidene fluoride, one obtained by modifying a part of its end and the like with a carboxylic acid such as maleic acid may be used. Polytetrafluoroethylene (PTFE) may be used as the fluorine-based binder. As the binder, synthetic rubber (fluorine rubber) may be used instead of the fluorine-based binder.

The content of the fluorine-based binder in the positive electrode active material layer 21B is 0.5% by mass or more and 2.8% by mass or less, preferably 0.7% by mass or more and 2.8% by mass or less. When the content of the fluorine-based binder is less than 0.5% by mass, binding between the positive electrode active material grains and binding between the positive electrode active material grains and the positive electrode current collector 21A become insufficient and the positive electrode active material layer 21B may peel off from the positive electrode current collector 21A when the positive electrode 21 is wound in a flat shape. Moreover, the coverage of the positive electrode active material grains with the fluorine-based binder becomes insufficient, it is difficult to suppress swelling of the battery 10, and the safety of the battery 10 may decrease. On the other hand, when the content of the fluorine-based binder exceeds 2.8% by mass, the flexibility of the positive electrode active material layer 21B decreases and cracking of the positive electrode active material layer 21B may occur when the positive electrode 21 is wound in a flat shape.

The content of the fluorine-based binder is measured, for example, as follows. First, the positive electrode 21 is taken out from the battery 10, washed with DMC, and dried. Next, a sample in an amount of several to several tens of mg is heated to 600° C. at a rate of temperature rise of 1° C./min to 5° C./min in an air atmosphere using a thermogravimetric-differential thermal analyzer (TG-DTA, for example, Rigaku Thermo plus TG8120 manufactured by Rigaku Corporation), and the content of the fluorine-based binder in the positive electrode active material layer 21B is determined from the amount of weight reduction at that time. Whether or not the amount of weight reduction due to the binder can be confirmed by isolating the binder, performing TG-DTA measurement of only the binder in an air atmosphere, and examining at what temperature the binder burns as described in the method for measuring the melting point of the binder.

Examples of the conductive agent include carbon materials such as graphite, carbon fibers, carbon black, Ketjen black, or carbon nanotubes. One of these may be used singly or two or more thereof may be used in mixture. In addition to the carbon materials, a metal material, a conductive polymer material, and the like may be used as long as the materials exhibit conductivity.

The content of the conductive agent in the positive electrode active material layer 21B is preferably 0.3% by mass or more and 2.8% by mass or less, more preferably 0.5% by mass or more and 2.8% by mass or less. When the content of the conductive agent is 0.3% by mass or more, the gas absorbing ability of the conductive agent is improved and swelling of the battery 10 can be further suppressed. Moreover, the flexibility of the positive electrode active material layer 21B is improved, and it is possible to suppress cracking of the positive electrode active material layer 21B when the positive electrode 21 is wound in a flat shape. On the other hand, when the content of the conductive agent is 2.8% by mass or less, the amount of the binder adsorbed to the conductive agent is suppressed, it is possible to suppress peeling off of the positive electrode active material layer 21B from the positive electrode current collector 21A when the positive electrode 21 is wound in a flat shape. Moreover, it is possible to suppress insufficient coverage of the positive electrode active material grains with the binder by suppressing the amount of the binder adsorbed to the conductive agent. Hence, the decrease in safety of the battery 10 can be suppressed.

The content of the conductive agent is measured, for example, as follows. First, the positive electrode 21 is taken out from the battery 10, washed with DMC, and dried. Next, a sample in an amount of several to several tens of mg is heated to 600° C. at a rate of temperature rise of 1C/min to 5° C./min in an air atmosphere using a thermogravimetric-differential thermal analyzer (TG-DTA, for example, Rigaku Thermo plus TG8120 manufactured by Rigaku Corporation). Thereafter, the content of the conductive agent is determined by subtracting the amount of weight reduction due to the combustion reaction of the binder from the amount of weight reduction at that time. Whether or not the amount of weight reduction due to the binder can be confirmed by isolating the binder, performing TG-DTA measurement of only the binder in an air atmosphere, and examining at what temperature the binder burns as described in the method for measuring the melting point of the binder.

The negative electrode 22 has a structure in which a negative electrode active material layer 22B is provided on one surface or both surfaces of a negative electrode current collector 22A and is disposed so that the negative electrode active material layer 22B and the positive electrode active material layer 21B face each other. Although it is not illustrated, the negative electrode active material layer 22B may be provided only on one surface of the negative electrode current collector 22A. The negative electrode current collector 22A is formed of, for example, a metal foil such as a copper foil, a nickel foil, or a stainless foil.

The negative electrode active material layer 22B contains one or two or more negative electrode active materials capable of storing and releasing lithium. The negative electrode active material layer 22B may further contain additives such as a binder and a conductive agent, if necessary.

In this battery 10, it is preferable that the electrochemical equivalent of the negative electrode 22 or the negative electrode active material is greater than the electrochemical equivalent of the positive electrode 21 and lithium metal is not deposited on the negative electrode 22 during charge in theory.

Examples of the negative electrode active material include carbon materials such as non-graphitizable carbon, graphitizable carbon, graphite, pyrolytic carbons, cokes, glassy carbons, organic polymer compound fired bodies, carbon fibers, or activated carbon. Among these, the cokes include pitch coke, needle coke, petroleum coke or the like. The term “organic polymer compound fired bodies” refers to one obtained by firing a polymer material such as phenol resin or furan resin at an appropriate temperature for carbonization, and some organic polymer compound fired bodies are classified as non-graphitizable carbon or graphitizable carbon. These carbon materials are preferable since the change in crystal structure that occurs at the time of charge and discharge is significantly small, a high charge and discharge capacitance can be attained, and favorable cycle characteristics can be attained. Particularly, graphite is preferable since graphite has a great electrochemical equivalent and a high energy density can be attained. Non-graphitizable carbon is preferable since excellent cycle characteristics can be attained. Furthermore, those having a low charge and discharge potential, specifically those having a charge and discharge potential close to that of lithium metal are preferable since it is possible to easily realize a high energy density of the battery 10.

Other negative electrode active materials capable of increasing the capacitance also include materials containing at least one of a metal element or a metalloid element as a constituent element (for example, an alloy, a compound, or a mixture). This is because a high energy density can be attained when such a material is used. In particular, it is more preferable to use these materials together with the carbon materials since it is possible to attain a high energy density and excellent cycle characteristics. In the present invention, the alloy also includes alloys containing one or more metal elements and one or more metalloid elements in addition to alloys composed of two or more metal elements. The alloy may contain a nonmetallic element. The texture thereof includes a solid solution, a eutectic (eutectic mixture), an intermetallic compound, or coexistence of two or more thereof.

Examples of such a negative electrode active material include a metal element or metalloid element capable of forming an alloy with lithium. Specific examples thereof include magnesium, boron, aluminum, titanium, gallium (Ga), indium (In), silicon (Si), germanium (Ge), tin, lead (Pb), bismuth (Bi), cadmium (Cd), silver (Ag), zinc, hafnium (Hf), zirconium, yttrium (Y), palladium (Pd), or platinum (Pt). These may be crystalline or amorphous.

The negative electrode active material preferably contains a metal element or metalloid element of the group 4B in the short periodic table as a constituent element and more preferably contains at least either of silicon or tin as a constituent element. This is because silicon and tin have a great ability to store and release lithium and a high energy density can be attained. Examples of such a negative electrode active material include a simple substance, an alloy, or a compound of silicon, and a simple substance, an alloy, or a compound of tin, and materials having one or two or more phases of these at least at a part.

Examples of the alloy of silicon include those containing at least one selected from the group consisting of tin, nickel, copper, iron, cobalt, manganese, zinc, indium, silver, titanium, germanium, bismuth, antimony (Sb), and chromium as the second constituent element other than silicon. Examples of the alloy of tin include those containing at least one selected from the group consisting of silicon, nickel, copper, iron, cobalt, manganese, zinc, indium, silver, titanium, germanium, bismuth, antimony, and chromium as the second constituent element other than tin.

Examples of the compound of tin or the compound of silicon include those containing oxygen or carbon, and the compound of tin or the compound of silicon may contain the above-mentioned second constituent elements in addition to tin or silicon.

Examples of other negative electrode active materials also include metal oxides or polymer compounds capable of storing and releasing lithium. Examples of the metal oxides include lithium-titanium oxide containing titanium and lithium such as lithium titanate (Li₄Ti₅O₁₂), iron oxide, ruthenium oxide, or molybdenum oxide. Examples of the polymer compounds include polyacetylene, polyaniline, or polypyrrole.

As the binder, for example, at least one selected from resin materials such as polyvinylidene fluoride, polytetrafluoroethylene, polyacrylonitrile, styrene-butadiene rubber, and carboxymethyl cellulose or copolymers containing these resin materials as main components is used.

As the conductive agent, similar carbon materials to those for the positive electrode active material layer 21B and the like can be used.

The separator 23 separates the positive electrode 21 and the negative electrode 22 from each other, prevents short circuit of current due to the contact between both electrodes, and allows lithium ions to pass through. The separator 23 is formed of, for example, a resin porous film such as polytetrafluoroethylene, polypropylene, or polyethylene and may have a structure in which two or more of these porous films are laminated. Among these, a polyolefin porous film is preferable since this has an excellent short circuit preventing effect and the safety of the battery 10 can be improved by the shutdown effect. Particularly, polyethylene is preferable as a material forming the separator 23 since polyethylene is also excellent in electrochemical stability and a shutdown effect can be attained in a range of 100° C. or more and 160° C. or less. In addition, a material obtained by copolymerizing or blending a resin exhibiting chemical stability with polyethylene or polypropylene can be used. Alternatively, the porous film may have a structure composed of three or more layers in which a polypropylene layer, a polyethylene layer, and a polypropylene layer are sequentially laminated.

The inner side surface of the outer peripheral side end portion of the positive electrode 21 is not provided with the positive electrode active material layer 21B but is provided with the positive electrode current collector exposed portion 21C₁ at which the inner side surface of the positive electrode current collector 21A is exposed. The outer side surface of the outer peripheral side end portion of the positive electrode 21 is not provided with the positive electrode active material layer 21B but is provided with the positive electrode current collector exposed portion 21D₁ at which the outer side surface of the positive electrode current collector 21A is exposed. The length of the positive electrode current collector exposed portion 21D₁ in the winding direction is, for example, longer than the length of the positive electrode current collector exposed portion 21C₁ in the winding direction by about one periphery.

The stepped portion at the boundary between the positive electrode current collector exposed portion 21C₁ and the positive electrode active material layer 21B and the positive electrode current collector exposed portion 21C₁ are covered with a protective tape 25A₁. The stepped portion at the boundary between the positive electrode current collector exposed portion 21D₁ and the positive electrode active material layer 21B and the positive electrode current collector exposed portion 21D₁ are covered with a protective tape 25B₁.

The inner side surface of the inner peripheral side end portion of the positive electrode 21 is not provided with the positive electrode active material layer 21B but is provided with the positive electrode current collector exposed portion 21C₂ at which the inner side surface of the positive electrode current collector 21A is exposed. The outer side surface of the inner peripheral side end portion of the positive electrode 21 is not provided with the positive electrode active material layer 21B but is provided with the positive electrode current collector exposed portion 21D₂ at which the outer side surface of the positive electrode current collector 21A is exposed. The lengths of the positive electrode current collector exposed portions 21C₂ and 21D₂ in the winding direction are, for example, substantially the same as each other. The positive electrode lead 11 is connected to the positive electrode collector exposed portion 21C₂.

The stepped portion at the boundary between the positive electrode current collector exposed portion 21C₂ and the positive electrode active material layer 21B and the positive electrode current collector exposed portion 21C₂ are covered with a protective tape 25A₂. The stepped portion at the boundary between the positive electrode current collector exposed portion 21D₂ and the positive electrode active material layer 21B and the positive electrode current collector exposed portion 21D₂ are covered with a protective tape 25B₂.

The inner side surface of the outer peripheral side end portion of the negative electrode 22 is not provided with the negative electrode active material layer 22B but is provided with the negative electrode current collector exposed portion 22C₁ at which the inner side surface of the negative electrode current collector 22A is exposed. The outer side surface of the outer peripheral side end portion of the negative electrode 22 is not provided with the negative electrode active material layer 22B but is provided with the negative electrode current collector exposed portion 22D₁ at which the outer side surface of the negative electrode current collector 22A is exposed. The lengths of the negative electrode current collector exposed portions 22C₁ and 22D₁ in the winding direction are, for example, substantially the same as each other.

The inner side surface of the inner peripheral side end portion of the negative electrode 22 is not provided with the negative electrode active material layer 22B but is provided with the negative electrode current collector exposed portion 22C₂ at which the inner side surface of the negative electrode current collector 22A is exposed. The outer side surface of the inner peripheral side end portion of the negative electrode 22 is not provided with the negative electrode active material layer 22B but is provided with the negative electrode current collector exposed portion 22D₂ at which the outer side surface of the negative electrode current collector 22A is exposed. The length of the negative electrode current collector exposed portion 22C₂ in the winding direction is, for example, longer than the length of the negative electrode current collector exposed portion 22D₂ in the winding direction by about one periphery. The negative electrode lead 12 is connected to the negative electrode collector exposed portion 22D₂.

A protective tape 26A is provided at the part of the negative electrode current collector exposed portion 22C₂ that faces the tip on the inner peripheral side of the positive electrode current collector 21A. A protective tape 26B is provided at the part of the negative electrode current collector exposed portion 22D₂ that faces the tip on the inner peripheral side of the positive electrode current collector 21A. The protective tapes 25A₁, 25A₂, 25B₁, 25B₂, 26A, and 26B may be provided if necessary or may not be provided.

The positive electrode current collector exposed portion 21C₁ provided at the outer peripheral side end portion of the positive electrode 21 and the negative electrode current collector exposed portion 22D₁ provided at the outer peripheral side end portion of the negative electrode 22 constitute the first facing portion at which these exposed portions face each other with the separator 23 interposed therebetween. The positive electrode current collector exposed portion 21D₁ provided at the outer peripheral side end portion of the positive electrode 21 and the negative electrode current collector exposed portion 22C₁ provided at the outer peripheral side end portion of the negative electrode 22 constitute the second facing portion at which these exposed portions face each other with the separator 23 interposed therebetween. By providing the first and second facing portions at the outer peripheral portion of the wound electrode body 20 in this manner, a low-resistance short circuit can be formed in an injury test such as a nail penetration test. Hence, the amount of Joule heat generated at the time of short circuiting can be suppressed and the safety can be improved.

The positive electrode current collector exposed portion 21C₂ provided at the inner peripheral side end portion of the positive electrode 21 and the negative electrode current collector exposed portion 22D₂ provided at the inner peripheral side end portion of the negative electrode 22 constitute the third facing portion at which these exposed portions face each other with the separator 23 interposed therebetween. The positive electrode current collector exposed portion 21D₂ provided at the inner peripheral side end portion of the positive electrode 21 and the negative electrode current collector exposed portion 22C₂ provided at the inner peripheral side end portion of the negative electrode 22 constitute the fourth facing portion at which these exposed portions face each other with the separator 23 interposed therebetween. By providing the third and fourth facing portions at the inner peripheral portion of the wound electrode body 20 in this manner, a low-resistance short circuit can be formed in an injury test such as a nail penetration test. Hence, the amount of Joule heat generated at the time of short circuiting can be suppressed and the safety can be improved.

From the viewpoint of improving safety, the first to fourth facing portions are preferably provided at least at the central portion of a flat surface 20S in the winding direction. From the viewpoint of further improving safety, the first to fourth facing portions are provided preferably over at least one flat surface 20S in the winding direction and more preferably over at least two flat surfaces 20S in the winding direction.

From the viewpoint of improving safety, the lengths of the first to fourth facing portions in the winding direction are provided over a range of preferably a ¼ periphery or more, more preferably a length equal to or more than the length of the flat surface 20S in the winding direction, still more preferably a half periphery or more, and particularly preferably one periphery or more. From the viewpoint of suppressing the decrease in energy density, the lengths of the first to fourth facing portions in the winding direction are provided over a range of preferably two peripheries or less, more preferably one and a half peripheries or less, still more preferably one periphery or less.

The electrolyte layer 24 is an example of an intermediate layer and contains a non-aqueous electrolytic solution and a fluororesin as a polymer compound, which serves as a retainer for retaining this non-aqueous electrolytic solution, and the fluororesin is swollen with the non-aqueous electrolytic solution. The content ratio of the fluororesin can be appropriately adjusted. As the electrolyte layer 24 contains the fluororesin, the close contact property between the positive electrode active material layer 21B containing the fluorine-based binder having a melting point of 166° C. or less and the separator 23 can be improved. The electrolyte layer 24 is preferably a gel-like electrolyte layer. This is because a high ionic conductivity can be attained and liquid leakage from the battery 10 can be particularly suppressed when the electrolyte layer 24 is a gel-like electrolyte layer.

The electrolytic solution contains a solvent and an electrolyte salt dissolved in this solvent. The electrolytic solution may contain a known additive in order to improve battery characteristics.

As the solvent, a cyclic carbonic acid ester such as ethylene carbonate or propylene carbonate can be used, and it is preferable to use either of ethylene carbonate or propylene carbonate, particularly both of these in mixture. This is because cycle characteristics can be improved.

As the solvent, it is preferable to use chain carbonic acid esters such as diethyl carbonate, dimethyl carbonate, ethyl methyl carbonate, or methyl propyl carbonate in mixture in addition to these cyclic carbonic acid esters. This is because high ionic conductivity can be attained.

It is preferable that the solvent further contains 2,4-difluoroanisole or vinylene carbonate. This is because 2,4-difluoroanisole can improve the discharge capacitance and vinylene carbonate can improve the cycle characteristics. Hence, it is preferable to use these in mixture since the discharge capacitance and the cycle characteristics can be improved.

In addition to these, examples of the solvent include butylene carbonate, γ-butyrolactone, Y-valerolactone, 1,2-dimethoxyethane, tetrahydrofuran, 2-methyltetrahydrofuran, 1,3-dioxolane, 4-methyl-1,3-dioxolane, methyl acetate, methyl propionate, acetonitrile, glutaronitrile, adiponitrile, methoxyacetonitrile, 3-methoxypropyronitrile, N,N-dimethylformamide, N-methylpyrrolidinone, N-methyloxazolidinone, N,N-dimethylimidazolidinone, nitromethane, nitroethane, sulfolane, dimethyl sulfoxide, or trimethyl phosphate.

A compound in which at least some of hydrogen atoms in these non-aqueous solvents are substituted with fluorine atoms may be preferable since this compound may be able to improve the reversibility of the electrode reaction depending on the kind of electrodes to be combined.

Examples of the electrolyte salt include a lithium salt, and one may be used singly or two or more may be used in mixture. Examples of the lithium salt include LiPF₆, LiBF₄, LiAsF₆, LiClO₄, LiB(C₆H₅)₄, LiCH₃SO₃, LiCF₃SO₃, LiN(SO₂CF₃)₂, LiC(SO₂CF₃)₃, LiAlCl₄, LiSiF₆, LiCl, lithium difluoro[oxolato-O,O′]borate, lithium bisoxalate borate, or LiBr. Among these, LiPF₆ is preferable since high ionic conductivity can be attained and cycle characteristics can be improved.

The fluororesin as a polymer compound contains, for example, at least one of polyvinylidene fluoride, a copolymer of vinylidene fluoride and hexafluoropropylene, polytetrafluoroethylene, or polyhexafluoropropylene. Particularly from the viewpoint of electrochemical stability, it is preferable to contain at least one of polyvinylidene fluoride or polyhexafluoropropylene.

In the battery 10 according to the first embodiment, the open circuit voltage (namely, battery voltage) in the fully charged state per pair of the positive electrode 21 and the negative electrode 22 may be less than 4.25 V but may be designed to be preferably 4.25 V or more, more preferably 4.3 V, still more preferably 4.4 V or more. A high energy density can be attained by increasing the battery voltage. The upper limit value of the open circuit voltage in the fully charged state per pair of the positive electrode 21 and the negative electrode 22 is preferably 6.00 V or less, more preferably 4.60 V or less, still more preferably 4.50 V or less.

In the battery 10 having the above-described configuration, when charge is performed, for example, lithium ions are released from the positive electrode active material layer 21B and stored in the negative electrode active material layer 22B via the electrolytic solution. When discharge is performed, for example, lithium ions are released from the negative electrode active material layer 22B and stored in the positive electrode active material layer 21B via the electrolytic solution.

Next, an example of the method for manufacturing the battery 10 according to the first embodiment of the present invention will be described.

The positive electrode 21 is fabricated as follows. First, for example, a positive electrode active material, a conductive agent, and a binder are mixed together to prepare a positive electrode mixture, and this positive electrode mixture is dispersed in a solvent such as N-methyl-2-pyrrolidone (NMP) to prepare a paste-like positive electrode mixture slurry. Next, this positive electrode mixture slurry is applied to the positive electrode current collector 21A, the solvent is dried, compression molding is performed using a roll pressing machine or the like to form the positive electrode active material layer 21B, and the positive electrode 21 is thus formed.

The negative electrode 22 is fabricated as follows. First, for example, a negative electrode active material and a binder are mixed together to prepare a negative electrode mixture, and this negative electrode mixture is dispersed in a solvent such as N-methyl-2-pyrrolidone to prepare a paste-like negative electrode mixture slurry. Next, this negative electrode mixture slurry is applied to the negative electrode current collector 22A, the solvent is dried, compression molding is performed using a roll pressing machine or the like to form the negative electrode active material layer 22B, and the negative electrode 22 is thus fabricated.

The electrolyte layer 24 is fabricated as follows. First, an electrolyte solution containing a matrix polymer, an electrolytic solution, and a diluting solvent is prepared. Next, this electrolyte solution is uniformly applied to and impregnated into each of the positive electrode 21 and negative electrode 22 obtained as described above. Thereafter, the diluting solvent is removed by vaporization to form the electrolyte layer 24.

The wound electrode body 20 is fabricated as follows. First, the positive electrode lead 11 is attached to the end portion of the positive electrode current collector 21A by welding and the negative electrode lead 12 is attached to the end portion of the negative electrode current collector 22A by welding. Next, the positive electrode 21 and negative electrode 22 on which the electrolyte layer 24 has been formed are stacked with the separator 23 interposed therebetween to form a stacked body, and then this stacked body is wound in its longitudinal direction, and the protective tape 25 is pasted to the outermost peripheral portion to form the wound electrode body 20.

The wound electrode body 20 is sealed with the exterior material 30 as follows. First, for example, the wound electrode body 20 is sandwiched between the flexible exterior material 30, and the outer edge portions of the exterior material 30 are brought into close contact with each other and sealed by heat seal or the like. At that time, the close contact film 31 is inserted between the positive electrode lead 11 and the exterior material 30 and between the negative electrode lead 12 and the exterior material 30. The close contact film 31 may be attached to each of the positive electrode lead 11 and the negative electrode lead 12 in advance. The exterior material 30 may be embossed in advance to form a concave portion as housing space for housing the wound electrode body 20. As described above, the battery 10 in which the wound electrode body 20 is housed in the exterior material 30 is obtained.

Next, the battery 10 is molded by heat pressing if necessary. More specifically, the battery 10 is heated at a temperature higher than room temperature while being pressurized. Next, a pressure plate or the like is pressed against the main surface of the battery 10 and the battery 10 is uniaxially pressurized if necessary.

The battery 10 according to the first embodiment is provided with both the following configurations (A) and (B) and the safety of the battery 10 can be thus improved. The swelling of the battery 10 due to gas generation can be suppressed. It is possible to suppress peeling off of the positive electrode active material layer 21B from the positive electrode current collector 21A and cracking of the positive electrode active material layer 21B when the positive electrode 21 is wound in a flat shape.

Configuration (A): The battery 10 includes the electrolyte layer 24 which contains a fluororesin and is provided between the positive electrode 21 and the separator 23 and between the negative electrode 22 and the separator 23 and the positive electrode active material layer 21B which contains a fluorine-based binder having a melting point of 166° C. or less and a conductive agent and in which the content of the fluorine-based binder is 0.5% by mass or more and 2.8% by mass or less and the content of the conductive agent is 0.3% by mass or more and 2.8% by mass or less.

Configuration (B): The positive electrode 21, negative electrode 22, and separator 23 are wound so that the positive electrode current collector exposed portions 21C₁ and 21D₁ and the negative electrode current collector exposed portions 22C₁ and 22D₁ face each other with the separator 23 interposed therebetween.

The effect on the improvement in safety is an unpredictable effect when the configurations (A) and (B) are each independently adopted. In other words, it is an effect attained by the configurations (A) and (B) being related functionally or applicatively.

It is presumed that exertion of the effect is due to the following reasons. The reaction leading to thermal runaway is considered to explosively proceed when the temperature exceeds a certain level. The mechanism for the improvement in safety of the positive electrode is mainly reaction suppression, but the reaction rapidly proceed and lead to thermal runaway when the battery is placed in a rather harsh situation. The temperature exceeds or does not exceed a certain level depending on the applied energy, Joule's heat generation caused by a short circuit in this case. Hence, by suppressing Joule's heat generation, it is possible to simultaneously cope with “a situation in which reaction is unlikely to occur” and “suppression of applied energy”, and a mechanism is presumed that remarkable improvement is achieved when the configurations (A) and (B) are simultaneously adopted as compared with the effect that is the sum of the effects attained when the configurations (A) and (B) are each independently adopted.

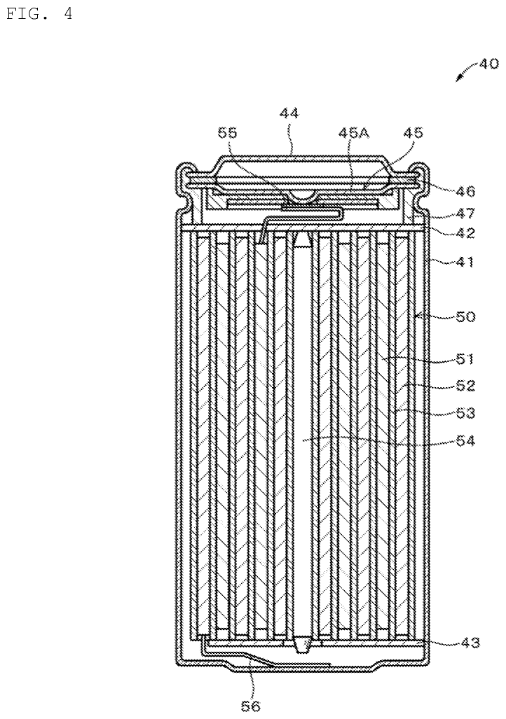

As illustrated in FIG. 4, a battery 40 according to a second embodiment of the present invention is a so-called cylindrical type and includes a wound electrode body 20 in which a pair of strip-like positive electrode 51 and strip-like negative electrode 52 are stacked with a separator 53 interposed therebetween and then wound inside a substantially hollow columnar battery can (exterior material) 41. The battery can 41 is formed of nickel-plated iron, aluminum or the like and has one end portion closed and the other end portion open. An electrolytic solution as a liquid electrolyte is injected into the battery can 41, and the positive electrode 51, the negative electrode 52, and the separator 53 are impregnated with the electrolytic solution. A pair of insulating plates 42 and 43 is disposed perpendicularly to the wound peripheral surface so as to sandwich the wound electrode body 50 therebetween. The electrolytic solution is similar to the electrolytic solution in the first embodiment.

A battery lid 44 and a safety valve mechanism 45 and a positive temperature coefficient element (PTC element) 46 which are provided inside this battery lid 44 are attached to the open end portion of the battery can 41 by being crimped with a sealing gasket 47 interposed therebetween. The inside of the battery can 41 is thus hermitically sealed. The battery lid 44 is formed of, for example, a material similar to that of the battery can 41. The safety valve mechanism 45 is electrically connected to the battery lid 44 and is configured so that a disk plate 15A is inverted to disconnect the electrical connection between the battery lid 44 and the wound electrode body 50 when the internal pressure of the battery is equal to or higher than a certain level by an internal short circuit, heating from the outside, or the like. The sealing gasket 47 is formed of, for example, an insulating material, and its surface is coated with asphalt.

For example, a center pin 54 is inserted in the center of the wound electrode body 50. A positive electrode lead 55 formed of aluminum or the like is connected to the positive electrode 51 of the wound electrode body 50, and a negative electrode lead 56 formed of nickel or the like is connected to the negative electrode 52. The positive electrode lead 55 is electrically connected to the battery lid 44 by being welded to the safety valve mechanism 45, and the negative electrode lead 56 is welded and electrically connected to the battery can 41.

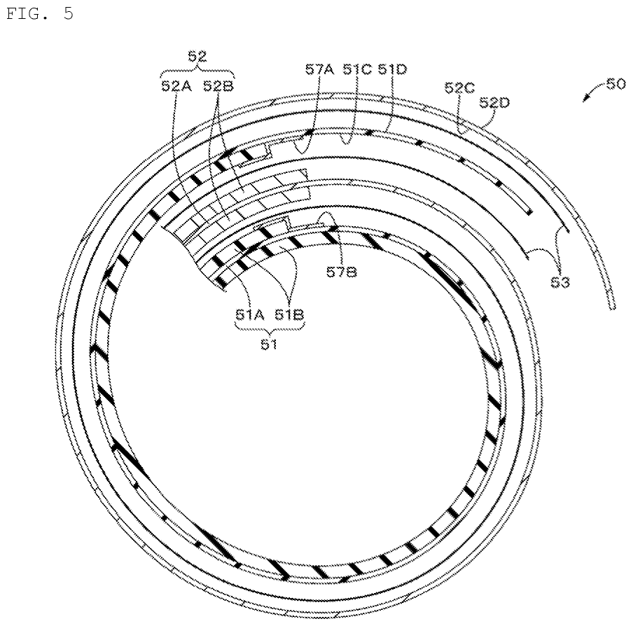

As illustrated in FIG. 5, the positive electrode 51 includes a positive electrode current collector 51A and a positive electrode active material layer 51B provided on both surfaces of the positive electrode current collector 51A. The negative electrode 52 includes a negative electrode current collector 52A and a negative electrode active material layer 52B provided on both surfaces of the negative electrode current collector 52A. The configurations of the positive electrode current collector 51A, the positive electrode active material layer 51B, the negative electrode current collector 52A, and the negative electrode active material layer 52B are similar to the configurations of the positive electrode current collector 21A, the positive electrode active material layer 21B, the negative electrode current collector 22A, and the negative electrode active material layer 22B in the first embodiment, respectively.

The inner side surface of the outer peripheral side end portion of the positive electrode 51 is not provided with the positive electrode active material layer 51B but is provided with the positive electrode current collector exposed portion 51C at which the inner side surface of the positive electrode current collector 51A is exposed. The outer side surface of the outer peripheral side end portion of the positive electrode 51 is not provided with the positive electrode active material layer 51B but is provided with the positive electrode current collector exposed portion 51D at which the outer side surface of the positive electrode current collector 51A is exposed. The length of the positive electrode current collector exposed portion 51D in the winding direction is, for example, longer than the length of the positive electrode current collector exposed portion 51C in the winding direction by about one periphery.

The stepped portion at the boundary between the positive electrode current collector exposed portion 51C and the positive electrode active material layer 51B is covered with a protective tape 57A. The stepped portion at the boundary between the positive electrode current collector exposed portion 51D and the positive electrode active material layer 51B is covered with a protective tape 57B.

The inner side surface of the outer peripheral side end portion of the negative electrode 52 is not provided with the negative electrode active material layer 52B but is provided with the negative electrode current collector exposed portion 52C at which the inner side surface of the negative electrode current collector 52A is exposed. The outer side surface of the outer peripheral side end portion of the negative electrode 52 is not provided with the negative electrode active material layer 52B but is provided with the negative electrode current collector exposed portion 52D at which the outer side surface of the negative electrode current collector 52A is exposed. The lengths of the negative electrode current collector exposed portions 52C and 52D in the winding direction are, for example, substantially the same as each other.

The positive electrode current collector exposed portion 51D provided at the outer periphery end portion of the positive electrode 51 and the negative electrode current collector exposed portion 52C provided at the outer periphery end portion of the negative electrode 52 constitute the facing portion at which these exposed portions face each other with the separator 53 interposed therebetween. By providing the facing portion at the outer peripheral portion of the wound electrode body 50 in this manner, a low-resistance short circuit can be formed in an injury test such as a nail penetration test. Hence, the amount of Joule heat generated at the time of short circuiting can be suppressed and the safety can be improved.

From the viewpoint of improving safety, the length of the facing portion in the winding direction is provided over a range of preferably a ¼ periphery or more, more preferably a half periphery or more, and particularly preferably one periphery or more. From the viewpoint of suppressing the decrease in energy density, the length of the facing portion in the winding direction is provided over a range of preferably two peripheries or less, more preferably one and a half peripheries or less.

The separator 53 has a configuration including a substrate and a surface layer provided on one surface or both surfaces of the substrate. The surface layer is an example of the intermediate layer and contains inorganic grains exhibiting electrical insulation property and a resin material which binds the inorganic grains to the surface of the substrate and the inorganic grains to each other. In a case in which the surface layer is provided only on one surface, the surface layer is preferably provided on the surface on the side facing the positive electrode 51. As the separator 53 includes the surface layer, the close contact property between the positive electrode active material layer 21B containing a fluorine-based binder having a melting point of 166° C. or less and the separator 53 can be enhanced, and it is thus possible to suppress swelling of the battery 40 and improve safety of the battery 40.

The resin material contained in the surface layer may be, for example, fibrillated and have a three-dimensional network structure in which the fibrils are continuously linked to each other. By supporting the inorganic grains on the resin material having this three-dimensional network structure, the inorganic grains can maintain the dispersed state without being linked to each other. The resin material may bind the surface of the substrate and the inorganic grains without being fibrillated. In this case, higher binding property can be attained. By providing the surface layer on one surface or both surfaces of the substrate as described above, oxidation resistance, heat resistance, and mechanical strength can be imparted to the substrate.

The substrate is a porous layer exhibiting porosity. More specifically, the substrate is a porous film formed of an insulating film having a high ion permeability and a predetermined mechanical strength, and the electrolytic solution is retained in the holes of the substrate. It is preferable that the substrate has characteristics to exhibit high resistance to the electrolytic solution, exhibit low reactivity, and hardly expand while having a predetermined mechanical strength as a main part of the separator.

It is preferable to use, for example, a polyolefin resin such as polypropylene or polyethylene, an acrylic resin, a styrene resin, a polyester resin, or a nylon resin as the resin material constituting the substrate. In particular, polyethylene such as low density polyethylene, high density polyethylene, and linear polyethylene, or low molecular weight wax components thereof, or a polyolefin resin such as polypropylene has a proper melting temperature and is easily procured, and thus is suitably used. A structure in which two or more of these porous films are laminated or a porous film formed by melting and kneading two or more of resin materials may be used. Those including a porous film formed of a polyolefin resin exhibit excellent separability between the positive electrode 21 and the negative electrode 22 and can further diminish the decrease in internal short circuit.

A nonwoven fabric may be used as the substrate. As the fibers constituting the nonwoven fabric, aramid fibers, glass fibers, polyolefin fibers, polyethylene terephthalate (PET) fibers, nylon fibers or the like can be used. A nonwoven fabric may be formed by mixing two or more of these fibers.

The inorganic grains contain, for example, at least one of a metal oxide, a metal nitride, a metal carbide, a metal sulfide or the like. The metal oxide preferably includes at least one of aluminum oxide (alumina, Al₂O₃), boehmite (hydrated aluminum oxide), magnesium oxide (magnesia, MgO), titanium oxide (titania, TO₂), zirconium oxide (zirconia, ZrO₂), silicon oxide (silica, SiO₂), yttrium oxide (yttria, Y₂O₃) or the like. The metal nitride preferably includes at least one of silicon nitride (Si₃N₄), aluminum nitride (AlN), boron nitride (BN), titanium nitride (TiN) or the like. The metal carbide preferably includes at least one of silicon carbide (SiC), boron carbide (B₄C) or the like. The metal sulfide preferably includes barium sulfate (BaSO₄) or the like. The inorganic grains may contain at least one among minerals such as porous aluminosilicate such as zeolite (M_{2/n}O.Al₂O₃.xSiO₂.yH₂O, M is a metal element, x≥2, y≥0), layered silicate, barium titanate (BaTiO₃), and strontium titanate (SrTiO₃). Among these, it is preferable to contain at least one of alumina, titania (particularly those having a rutile type structure), silica, or magnesia and it is more preferable to contain alumina. The inorganic grains exhibit oxidation resistance and heat resistance, and the surface layer of the positive electrode-facing side surface containing the inorganic grains exhibits strong resistance to the oxidizing environment in the vicinity of the positive electrode at the time of charge. The shape of the inorganic grains is not particularly limited, and any of spherical, plate-like, fibrous, cubic, or random-shaped inorganic grains can be used.

Examples of the resin material forming the surface layer include resins exhibiting high heat resistance as at least either of the melting point or the glass transition temperature thereof is 180° C. or more such as fluorine-containing resins such as polyvinylidene fluoride and polytetrafluoroethylene, fluorine-containing rubber such as vinylidene fluoride-tetrafluoroethylene copolymer and ethylene-tetrafluoroethylene copolymer, rubbers such as styrene-butadiene copolymer or hydrides thereof, acrylonitrile-butadiene copolymer or hydrides thereof, acrylonitrile-butadiene-styrene copolymer or hydrides thereof, methacrylic acid ester-acrylic acid ester copolymer, styrene-acrylic acid ester copolymer, acrylonitrile-acrylic acid ester copolymer, ethylene propylene rubber, polyvinyl alcohol, and polyvinyl acetate, cellulose derivatives such as ethyl cellulose, methyl cellulose, hydroxyethyl cellulose, and carboxymethyl cellulose, polyphenylene ether, polysulfone, polyether sulfone, polyphenylene sulfide, polyetherimide, polyimide, polyamide such as wholly aromatic polyamide (aramid), polyamide-imide, polyacrylonitrile, polyvinyl alcohol, polyether, an acrylic acid resin, or polyester. These resin materials may be used singly or in mixture of two or more thereof. Among these, a fluorine-based resin such as polyvinylidene fluoride is preferable from the viewpoint of oxidation resistance and flexibility and it is preferable to contain aramid or polyamide-imide from the viewpoint of heat resistance.

The grain size of the inorganic grains is preferably in a range of 1 nm to 10 μm. When the grain size is smaller than 1 nm, it is difficult to procure the inorganic grains and it is not worth the cost even if the inorganic grains can be procured. On the other hand, when the grain size is larger than 10 μm, the distance between electrodes is far, the amount of active material filled in the limited spaces not sufficiently attained, and the battery capacitance is low.

As the method for forming the surface layer, it is possible to use, for example, a method in which a slurry containing a matrix resin, a solvent, and an inorganic material is applied onto a substrate (porous film) and the applied slurry is allowed to pass through a poor solvent of the matrix resin and a bath of a good solvent of the solvent for phase separation and then dried.

The above-described inorganic grains may be contained in the porous film as a substrate.

The surface layer may not contain inorganic grains but may be formed only of a resin material. In this case, a fluororesin is used as the resin material. Even in a case in which the surface layer does not contain inorganic grains, if the surface layer contains a fluororesin, the close contact property between the positive electrode active material layer 51B containing a fluorine-based binder having a melting point of 166° C. or less and the separator 53 can be enhanced, and it is thus possible to improve safety of the battery 40.

Examples of the fluororesin include resins exhibiting high heat resistance as at least either of the melting point or the glass transition temperature thereof is 180° C. or more, such as fluorine-containing resins such as polyvinylidene fluoride and polytetrafluoroethylene and fluorine-containing rubber such as vinylidene fluoride-tetrafluoroethylene copolymer and ethylene-tetrafluoroethylene copolymer. These resin materials may be used singly or in mixture of two or more thereof.

In the second embodiment, an example in which the present invention is applied to a cylindrical type battery provided with a metal can as an exterior material has been described, but the present invention is preferably applied to a laminate film type battery, particularly a laminate film type battery having a flat shape. This is due to the following reasons. In other words, in the case of a cylindrical type battery, swelling of the battery hardly occurs since the exterior material is a metal can. Moreover, cracking of the electrode is less likely to occur when the wound electrode body is wound since the wound electrode body has a cylindrical shape. In contrast, in a laminate film type battery, swelling of the battery is likely to occur since the exterior material is a laminate film. Moreover, cracking of the electrode is likely to occur when the wound electrode body is wound since the wound electrode body has a flat shape.

In a third embodiment, a battery pack and an electronic device which include the battery according to the above-described first or second embodiment will be described.

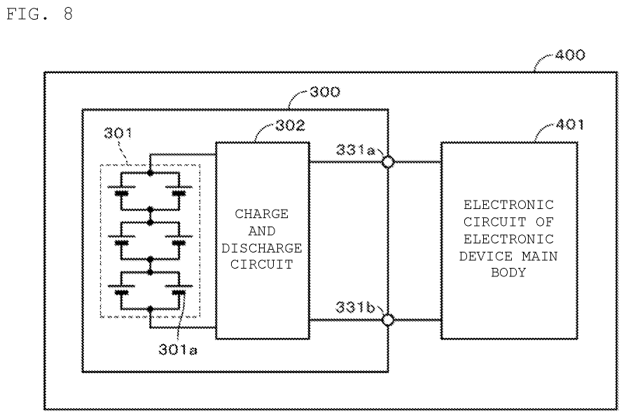

FIG. 8 illustrates an example of the configurations of a battery pack 300 and an electronic device 400 as an application example. The electronic device 400 includes an electronic circuit 401 of the electronic device main body and the battery pack 300. The battery pack 300 is electrically connected to the electronic circuit 401 via a positive electrode terminal 331a and a negative electrode terminal 331b. The electronic device 400 has, for example, a configuration in which the battery pack 300 is freely attached and detached by the user. The configuration of the electronic device 400 is not limited to this, and the electronic device 400 may have a configuration in which the battery pack 300 is built in the electronic device 400 so that the user cannot be detached the battery pack 300 from the electronic device 400.

When the battery pack 300 is charged, the positive electrode terminal 331a and negative electrode terminal 331b of the battery pack 300 are connected to the positive electrode terminal and negative electrode terminal of a charger (not illustrated), respectively. On the other hand, when the battery pack 300 is discharged (when the electronic device 400 is used), the positive electrode terminal 331a and negative electrode terminal 331b of the battery pack 300 are connected to the positive electrode terminal and negative electrode terminal of the electronic circuit 401, respectively.

Examples of the electronic device 400 include laptop personal computers, tablet computers, mobile phones (for example, smartphones), personal digital assistants (PDA), display devices (LCD, EL display, electronic paper and the like), imaging devices (for example, digital still cameras, digital video cameras and the like), audio devices (for example, portable audio players), game consoles, cordless phones, e-books, electronic dictionaries, radios, headphones, navigation systems, memory cards, pacemakers, hearing aids, electric power tools, electric shavers, refrigerators, air conditioners, TVs, stereos, water heaters, microwave ovens, dishwashers, washing machines, dryers, lighting equipment, toys, medical equipment, robots, road conditioners, and traffic lights, but the electronic device 400 is not limited thereto.

The electronic circuit 401 includes, for example, a CPU, a peripheral logic unit, an interface unit, a storage unit, and the like and controls the entire electronic device 400.

The battery pack 300 includes an assembled battery 301 and a charge and discharge circuit 302. The battery pack 300 may further include an exterior material (not illustrated) which houses the assembled battery 301 and the charge and discharge circuit 302, if necessary.

The assembled battery 301 is configured by connecting a plurality of secondary batteries 301a in series and/or in parallel. The plurality of secondary batteries 301a are connected, for example, n in parallel and m in series (n and m are positive integers). FIG. 8 illustrates an example in which six secondary batteries 301a are connected two in parallel and three in series (2P3S). As the secondary battery 301a, the battery according to the first or second embodiment described above is used.

Here, a case in which the battery pack 300 includes the assembled battery 301 including the plurality of secondary batteries 301a is described, but a configuration in which the battery pack 300 includes one secondary battery 301a instead of the assembled battery 301 may be adopted.

The charge and discharge circuit 302 is a control unit which controls charge and discharge of the assembled battery 301. Specifically, the charge and discharge circuit 302 controls charge of the assembled battery 301 at the time of charge. On the other hand, the charge and discharge circuit 302 controls discharge of the electronic device 400 at the time of discharge (that is, when the electronic device 400 is used).

As the exterior material, for example, a case formed of a metal, a polymer resin, or a composite material thereof can be used. Examples of the composite material include a laminated body in which a metal layer and a polymer resin layer are laminated.

The embodiments of the present invention have been specifically described above, but the present invention is not limited to the above-described embodiments, and various modifications can be made based on the technical idea of the present invention.

For example, the configurations, methods, steps, shapes, materials, numerical values and the like mentioned in the above-described embodiments are merely examples, and configurations, methods, steps, shapes, materials, numerical values and the like different from these may be used, if necessary. The chemical formulas of compounds and the like are representative ones, and the valences and the like are not limited to the described ones as long as the names are common names of the same compounds.

The configurations, methods, steps, shapes, materials, numerical values and the like of the above-described embodiments can be combined with each other without departing from the gist of the present invention.

### Modification Example 1

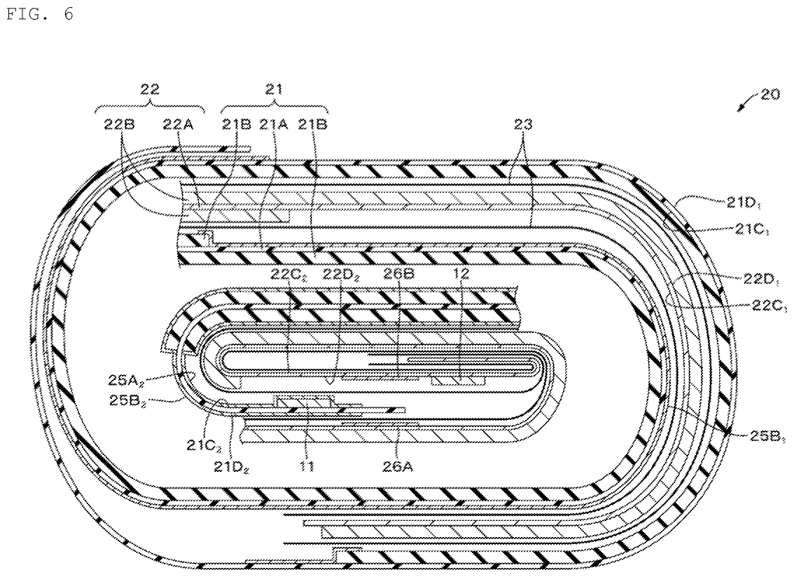

In the first embodiment, a case in which the wound electrode body 20 includes both the first facing portion at which the positive electrode current collector exposed portion 21C and the negative electrode current collector exposed portion 22D₁ face each other with the separator 23 interposed therebetween and the second facing portion at which the positive electrode current collector exposed portion 21D₁ and the negative electrode current collector exposed portion 22C₁ face each other with the separator 23 interposed therebetween has been described, but the configuration of the wound electrode body 20 is not limited to this. For example, the wound electrode body 20 may include only the second facing portion as illustrated in FIG. 6. In this case, the wound electrode body 20 may be configured so that the inner side surface of the outer peripheral side end portion of the negative electrode 22 is not provided with the negative electrode active material layer 22B but is provided with the negative electrode current collector exposed portion 22C₁ at which the inner side surface of the negative electrode current collector 22A is exposed while the outer side surface of the outer peripheral side end portion of the negative electrode 22 is provided with the negative electrode active material layer 22B and the outer side surface of the negative electrode current collector 22A is not substantially exposed. Although it is not illustrated, the wound electrode body 20 may include only the first facing portion.

### Modification Example 2

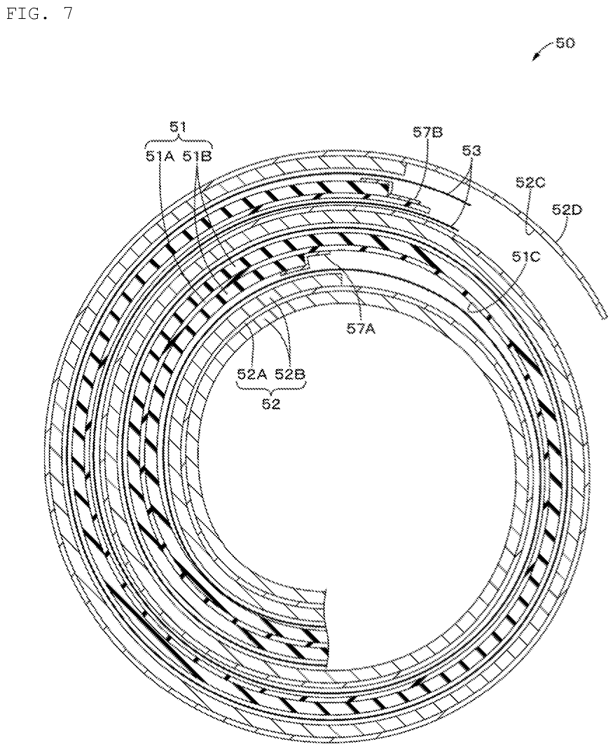

In the second embodiment, a case in which the wound electrode body 50 is configured so that the positive electrode current collector exposed portion 51D provided on the outer side surface of the positive electrode 51 and the negative electrode current collector exposed portion 52C provided on the inner side surface of the negative electrode 52 constitute the facing portion at which these exposed portions face each other with the separator 53 interposed therebetween has been described, but the configuration of the wound electrode body 50 is not limited to this. For example, as illustrated in FIG. 7, the wound electrode body 50 may be configured so that the positive electrode current collector exposed portion 51C provided on the inner side surface of the positive electrode 51 and the negative electrode current collector exposed portion 52D provided on the outer side surface of the negative electrode 52 constitute the facing portion at which these exposed portions face each other with the separator 53 interposed therebetween. In this case, the wound electrode body 50 may be configured so that the outer side surface of the outer peripheral side end portion of the positive electrode 51 is provided with the positive electrode active material layer 51B and the outer side surface of the positive electrode current collector 51A is not substantially exposed.

### Modification Example 3

In the first embodiment, a case in which the facing portions at which the positive electrode current collector exposed portions and the negative electrode current collector exposed portions face each other with the separator 23 interposed therebetween are provided on both the inner peripheral side end portion and outer peripheral side end portion of the wound electrode body 20 has been described, but the facing portions may be provided at either of the inner peripheral side end portion or outer peripheral side end portion of the wound electrode body 20. However, from the viewpoint of improving safety, it is preferable that the facing portions are provided on both the inner peripheral side end portion and outer peripheral side end portion of the wound electrode body 20 as in the first embodiment.

In a case in which the facing portions are provided at either of the inner peripheral side end portion or outer peripheral side end portion of the wound electrode body 20, it is preferable to provide the facing portions on the outer peripheral side end portion of the wound electrode body 20 from the viewpoint of improving safety. The positions at which the facing portions are provided are not limited to the inner peripheral side and outer peripheral side end portions of the wound electrode body 20, and the facing portions may be provided at a position other than the inner peripheral side end portion and the outer peripheral side end portion, for example, at the middle peripheral portion of the wound electrode body 20.

### Modification Example 4

The positive electrode active material layers 21B and 51B may contain a binder other than the fluorine-based binder, if necessary. For example, the positive electrode active material layers 21B and 51B may contain at least one selected from resin materials such as polyacrylonitrile (PAN), styrene-butadiene rubber (SBR), and carboxymethyl cellulose (CMC), copolymers containing these resin materials as main components or the like other than the fluorine-based binder.

The positive electrode active material layers 21B and 51B may contain a fluorine-based binder other than polyvinylidene fluoride, if necessary. For example, the positive electrode active material layers 21B and 51B may contain at least one of polytetrafluoroethylene (PTFE) or a VdF-based copolymer containing VdF as one of monomers other than polyvinylidene fluoride.

As the VdF-based copolymer, for example, it is possible to use a copolymer of vinylidene fluoride (VdF) and at least one selected from the group consisting of hexafluoropropylene (HFP), chlorotrifluoroethylene (CTFE), tetrafluoroethylene (TFE) and the like. More specifically, it is possible to use at least one selected from the group consisting of PVdF-HFP copolymer, PVdF-CTFE copolymer, PVdF-TFE copolymer, PVdF-HFP-CTFE copolymer, PVdF-HFP-TFE copolymer, PVdF-CTFE-TFE copolymer, PVdF-HFP-CTFE-TFE copolymer and the like. As the VdF-based copolymer, one obtained by modifying a part of its end and the like with a carboxylic acid such as maleic acid may be used.

### Modification Example 5

The battery 10 according to the first embodiment may include the separator 53 in the second embodiment instead of the separator 23 and an electrolytic solution instead of the electrolyte layer 24. In this case as well, a similar effect to that by the battery according to the first embodiment can be attained.

### Modification Example 6

The battery 40 according to the second embodiment may include the separator 23 and the electrolyte layer 24 in the first embodiment instead of the separator 53 and an electrolytic solution.

### Modification Example 7

In the battery 10 according to the first embodiment, the electrolyte layer 24 provided between the positive electrode 21 and the separator 23 may further contain grains. The grains are similar to the grains used in the separator 53 in the second embodiment. Similarly, the electrolyte layer 24 provided between the negative electrode 22 and the separator 23 may further contain grains.

### Modification Example 8

In the battery 10 according to the first embodiment, the electrolyte layer 24 provided between the positive electrode 21 and the separator 23 may contain a resin other than a fluororesin and grains. The grains are similar to the grains used in the separator 53 in the second embodiment. Similarly, the electrolyte layer 24 provided between the negative electrode 22 and the separator 23 may contain a resin other than a fluororesin and grains.

### Modification Example 9

In the first embodiment, a case in which both the electrolyte layer 24 provided between the positive electrode 21 and the separator 23 and the electrolyte layer 24 provided between the negative electrode 22 and the separator 23 contain a fluororesin has been described, but the electrolyte layer 24 provided between the negative electrode 22 and the separator 23 may or may not contain a fluororesin. In this case, the electrolyte layer 24 provided between the negative electrode 22 and the separator 23 contains, for example, at least one of polyacrylonitrile, polyvinylidene fluoride, a copolymer of vinylidene fluoride and hexafluoropropylene, polytetrafluoroethylene, polyhexafluoropropylene, polyethylene oxide, polypropylene oxide, polyphosphazene, polysiloxane, polyvinyl acetate, polyvinyl alcohol, polymethyl methacrylate, polyacrylic acid, polymethacrylic acid, styrene-butadiene rubber, nitrile-butadiene rubber, polystyrene, or polycarbonate as the polymer compound. Particularly from the viewpoint of electrochemical stability, it is preferable to contain at least one of polyacrylonitrile, polyvinylidene fluoride, polyhexafluoropropylene, or polyethylene oxide.

### Modification Example 10

In the first and second embodiments, examples in which the present invention is applied to batteries having a flat shape and a cylindrical shape have been described, but the present invention is also applicable to batteries having a rectangular shape, a curved shape, or a bent shape. The present invention is also applicable to flexible batteries.

### EXAMPLES

Hereinafter, the present invention will be specifically described with reference to Examples, but the present invention is not limited only to these Examples.

In the following Examples and Comparative Examples, foil-foil structures 1 and 2 and a normal structure 1 refer to the following outer peripheral portion structures of the wound electrode body.

Foil-foil structure 1: the structure of the first and second facing portions described in the first embodiment (see FIG. 2)

Foil-foil structure 2: the structure of the second facing portion described in modification example 1 (see FIG. 6)

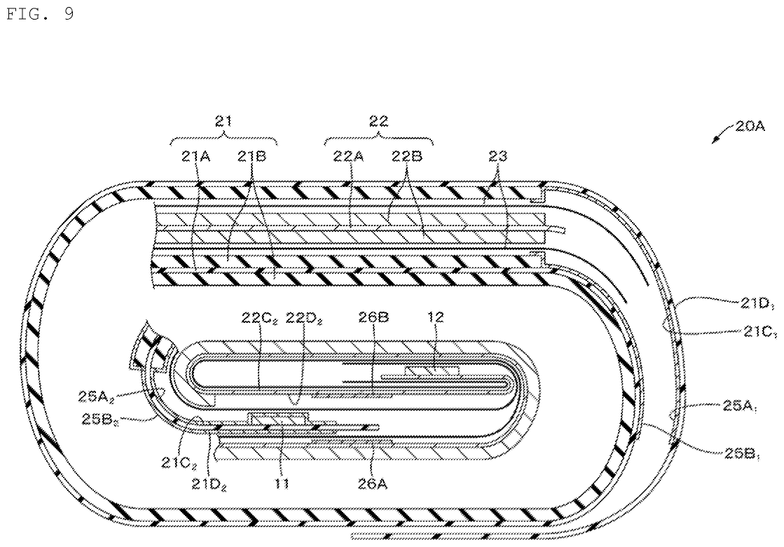

Normal structure 1: a structure in which the outer peripheral portion of the cylindrical wound electrode body 20A is not provided with a facing portion at which the positive electrode current collector exposed portion and the negative electrode current collector exposed portion face each other as illustrated in FIG. 9.

### Example 1-1-A

The positive electrode was fabricated as follows. A positive electrode mixture was obtained by mixing 99.2% by mass of lithium-cobalt composite oxide (LiCoO₂) as a positive electrode active material, 0.5% by mass of polyvinylidene fluoride (PVdF (homopolymer of vinylidene fluoride)) having a melting point of 155° C. as a binder, and 0.3% by mass of carbon nanotubes as a conductive agent, and then this positive electrode mixture was dispersed in an organic solvent (N-methyl-2-pyrrolidone: NMP) to obtain a paste-like positive electrode mixture slurry. Subsequently, the positive electrode current collector (aluminum foil) was coated with the positive electrode mixture slurry using a coating apparatus and then dried to form a positive electrode active material layer. Finally, the positive electrode active material layer was compression-molded using a pressing machine.

The negative electrode was fabricated as follows. First, a negative electrode mixture was obtained by mixing 96% by mass of artificial graphite powder as a negative electrode active material, 1% by mass of styrene-butadiene rubber (SBR) as a first binder, 2% by mass of polyvinylidene fluoride (PVdF) as a second binder, and 1% by mass of carboxymethyl cellulose (CMC) as a thickener, and then this negative electrode mixture was dispersed in a solvent to obtain a paste-like negative electrode mixture slurry. Subsequently, the negative electrode current collector (copper foil) was coated with the negative electrode mixture slurry using a coating apparatus and then dried. Finally, the negative electrode active material layer was compression-molded using a pressing machine.

The electrolytic solution was prepared as follows. First, ethylene carbonate (EC), propylene carbonate (PC), and diethyl carbonate (DEC) were mixed together at a mass ratio of EC:PC:DEC=15:15:70 to prepare a mixed solvent. Subsequently, an electrolytic solution was prepared by dissolving lithium hexafluorophosphate (LiPF₆) as an electrolyte salt in this mixed solvent so as to have a concentration of 1 mol/l.

A laminate type battery was fabricated as follows. First, the positive electrode and the negative electrode were cut (slit) into predetermined sizes, then an aluminum positive electrode lead was welded to the positive electrode current collector, and a copper negative electrode lead was welded to the negative electrode current collector. Subsequently, the positive electrode and the negative electrode were brought into close contact with each other with a separator obtained by coating both surfaces of a microporous polyethylene film with a fluororesin (vinylidene fluoride-hexafluoropropylene copolymer (VDF-HFP copolymer)) interposed therebetween, and then wound in the longitudinal direction, and a protective tape was attached to the outermost peripheral portion to fabricate a flat wound electrode body. In the step of fabricating the positive electrode and the step of fabricating the negative electrode, the application positions of the positive electrode mixture slurry and negative electrode mixture slurry were adjusted so that the foil-foil structure 1 (see FIG. 2) was formed on the outer peripheral portion of the wound electrode body.

Next, this wound electrode body was loaded between the exterior materials, and three sides of the exterior materials were heat-sealed, and one side was not heat-sealed but was open. As the exterior material, a moisture proof aluminum laminate film in which a 25 μm thick nylon film, a 40 μm thick aluminum foil, and a 30 μm thick polypropylene film were laminated in this order from the outermost layer was used.

Thereafter, the electrolytic solution was injected through the opening of the exterior material, and the remaining one side of the exterior material was heat-sealed under reduced pressure to hermetically seal the wound electrode body. The intended laminate type battery was thus obtained. This laminate type battery is designed so that the open circuit voltage (namely, battery voltage) at full charge is 4.40 V by adjusting the amount of positive electrode active material and the amount of negative electrode active material.

### Example 1-2-A

A laminate type battery was obtained in the same manner as in Example 1-1-A except that the application positions of the positive electrode mixture slurry and negative electrode mixture slurry were adjusted in the step of fabricating the positive electrode and the step of fabricating the negative electrode so that the foil-foil structure 2 (see FIG. 6) was formed on the outer peripheral portion of the wound electrode body.

### Example 1-3-A

A laminate type battery was obtained in the same manner as in Example 1-1-A except that a separator in which alumina was held on both surfaces of a microporous polyethylene film.

### Example 1-4-A

A laminate type battery was obtained in the same manner as in Example 1-2-A except that a separator in which alumina was held on both surfaces of a microporous polyethylene film.

### Example 1-5-A

A laminate type battery was obtained in the same manner as in Example 1-1-A except that a microporous polyethylene film was used as a separator, one in which a gel-like electrolyte layer was formed on the positive electrode and negative electrode was used, and the electrolytic solution was not injected.

The gel-like electrolyte layer was formed as follows. First, ethylene carbonate (EC) and propylene carbonate (PC) were mixed together at a mass ratio of EC:PC=50:50 to prepare a mixed solvent. Subsequently, an electrolytic solution was prepared by dissolving lithium hexafluorophosphate (LiPF₆) as an electrolyte salt in this mixed solvent so as to have a concentration of 1 mol/l.

Next, a precursor solution containing the prepared electrolytic solution, polyvinylidene fluoride (PVdF) as a polymer compound for electrolyte, and dimethyl carbonate (DMC) as an organic solvent was prepared, and then the precursor solution was applied to the positive electrode and the negative electrode to form gel-like electrolyte layers.

### Example 1-6-A

A laminate type battery was obtained in the same manner as in Example 1-2-A except that a microporous polyethylene film was used as a separator, one in which a gel-like electrolyte layer was formed on the positive electrode and negative electrode was used, and the electrolytic solution was not injected. The gel-like electrolyte layer was performed in the same manner as in Example 1-5-A.

### Examples 1-7-A, 1-8-A, and 1-9-A

Laminate type batteries were obtained in the same manner as in Examples 1-1-A, 1-3-A, and 1-5-A except that a positive electrode mixture was obtained by mixing 98.8% by mass of lithium-cobalt composite oxide (LiCoO₂) as a positive electrode active material, 0.7% by mass of polyvinylidene fluoride (PVdF) having a melting point of 155° C. as a binder, and 0.5% by mass of carbon black as a conductive agent.

### Examples 1-10-A and 1-11-A

Laminate type batteries were obtained in the same manner as in Examples 1-1-A and 1-5-A except that a positive electrode mixture was obtained by mixing 97.1% by mass of lithium-cobalt composite oxide (LiCoO₂) as a positive electrode active material, 1.4% by mass of polyvinylidene fluoride (PVdF) having a melting point of 155° C. as a binder, and 1.5% by mass of carbon black as a conductive agent.

### Examples 1-12-A, 1-13-A, 1-14-A, 1-15-A, 1-16-A, and 1-17-A

Laminate type batteries were obtained in the same manner as in Examples 1-1-A, 1-2-A, 1-3-A, 1-4-A, 1-5-A, and 1-6-A except that a positive electrode mixture was obtained by mixing 94.4% by mass of lithium-cobalt composite oxide (LiCoO₂) as a positive electrode active material, 2.8% by mass of polyvinylidene fluoride (PVdF) having a melting point of 155° C. as a binder, and 2.8% by mass of carbon black as a conductive agent.

### Comparative Examples 1-1-A, 1-2-A, and 1-3-A

Laminate type batteries were obtained in the same manner as in Examples 1-1-A, 1-3-A, and 1-5-A except that the application positions of the positive electrode mixture slurry and negative electrode mixture slurry were adjusted in the step of fabricating the positive electrode and the step of fabricating the negative electrode so that the normal structure 1 (see FIG. 9) was formed on the outer peripheral portion of the wound electrode body.

### Comparative Examples 1-4-A, 1-5-A, and 1-6-A

Laminate type batteries were obtained in the same manner as in Comparative Examples 1-1-A, 1-2-A, and 1-3-A except that a positive electrode mixture was obtained by mixing 98.8% by mass of lithium-cobalt composite oxide (LiCoO₂) as a positive electrode active material, 0.7% by mass of polyvinylidene fluoride (PVdF) having a melting point of 155° C. as a binder, and 0.5% by mass of carbon black as a conductive agent.

### Comparative Examples 1-7-A and 1-8-A

Laminate type batteries were obtained in the same manner as in Comparative Examples 1-1-A and 1-3-A except that a positive electrode mixture was obtained by mixing 97.1% by mass of lithium-cobalt composite oxide (LiCoO₂) as a positive electrode active material, 1.4% by mass of polyvinylidene fluoride (PVdF) having a melting point of 155° C. as a binder, and 1.5% by mass of carbon black as a conductive agent.

### Comparative Examples 1-9-A, 1-10-A, and 1-11-A

Laminate type batteries were obtained in the same manner as in Comparative Examples 1-1-A, 1-2-A, and 1-3-A except that a positive electrode mixture was obtained by mixing 94.4% by mass of lithium-cobalt composite oxide (LiCoO₂) as a positive electrode active material, 2.8% by mass of polyvinylidene fluoride (PVdF) having a melting point of 155° C. as a binder, and 2.8% by mass of carbon black as a conductive agent.

### Comparative Examples 1-1-B, 1-2-B, and 1-3-B

Laminate type batteries were obtained in the same manner as in Comparative Examples 1-1-A, 1-4-A, and 1-7-A except that a microporous polyethylene film was used as a separator.

### Comparative Examples 1-4-B, 1-5-B, and 1-6-B

Laminate type batteries were obtained in the same manner as in Comparative Examples 1-1-A, 1-2-A, and 1-3-A except that a positive electrode mixture was obtained by mixing 94.3% by mass of lithium-cobalt composite oxide (LiCoO₂) as a positive electrode active material, 2.8% by mass of polyvinylidene fluoride (PVdF) having a melting point of 155° C. as a binder, and 2.9% by mass of carbon black as a conductive agent.

### Comparative Examples 1-7-B and 1-8-B

Laminate type batteries were obtained in the same manner as in Comparative Examples 1-1-A and 1-2-A except that a positive electrode mixture was obtained by mixing 94.2% by mass of lithium-cobalt composite oxide (LiCoO₂) as a positive electrode active material, 2.8% by mass of polyvinylidene fluoride (PVdF) having a melting point of 155° C. as a binder, and 3.0% by mass of carbon black as a conductive agent.

### Comparative Examples 1-9-B, 1-10-B, 1-11-B, and 1-12-B

Laminate type batteries were obtained in the same manner as in Comparative Examples 1-1-A, 1-2-A, 1-1-B, and 1-3-A except that a positive electrode mixture was obtained by mixing 94.1% by mass of lithium-cobalt composite oxide (LiCoO₂) as a positive electrode active material, 2.9% by mass of polyvinylidene fluoride (PVdF) having a melting point of 155° C. as a binder, and 3.0% by mass of carbon black as a conductive agent.

### Comparative Example 1-13-B

A Laminate type battery was obtained in the same manner as in Comparative Example 1-3-A except that a positive electrode mixture was obtained by mixing 93.5% by mass of lithium-cobalt composite oxide (LiCoO) as a positive electrode active material, 3.5% by mass of polyvinylidene fluoride (PVdF) having a melting point of 155° C. as a binder, and 3.0% by mass of carbon black as a conductive agent.

### Comparative Examples 1-1-C and 1-2-C

Laminate type batteries were obtained in the same manner as in Examples 1-1-A and 1-2-A except that a microporous polyethylene film was used as a separator.

### Comparative Examples 1-3-C and 1-4-C

Laminate type batteries were obtained in the same manner as in Examples 1-7-A and 1-10-A except that a microporous polyethylene film was used as a separator.

### Comparative Examples 1-5-C, 1-6-C, and 1-7-C

Laminate type batteries were obtained in the same manner as in Comparative Examples 1-4-B, 1-5-B, and 1-6-B except that the application positions of the positive electrode mixture slurry and negative electrode mixture slurry were adjusted in the step of fabricating the positive electrode and the step of fabricating the negative electrode so that the foil-foil structure 1 (see FIG. 2) was formed on the outer peripheral portion of the wound electrode body.

### Comparative Examples 1-8-C and 1-9-C

Laminate type batteries were obtained in the same manner as in Examples 1-1-A and 1-2-A except that a positive electrode mixture was obtained by mixing 94.2% by mass of lithium-cobalt composite oxide (LiCoO) as a positive electrode active material, 2.8% by mass of polyvinylidene fluoride (PVdF) having a melting point of 155° C. as a binder, and 3.0% by mass of carbon black as a conductive agent.

### Comparative Examples 1-10-C and 1-11-C

Laminate type batteries were obtained in the same manner as in Examples 1-3-A and 1-4-A except that a positive electrode mixture was obtained by mixing 94.2% by mass of lithium-cobalt composite oxide (LiCoO₂) as a positive electrode active material, 2.8% by mass of polyvinylidene fluoride (PVdF) having a melting point of 155° C. as a binder, and 3.0% by mass of carbon black as a conductive agent.

### Comparative Examples 1-12-C, 1-13-C, and 1-14-C

Laminate type batteries were obtained in the same manner as in Comparative Examples 1-5-C, 1-6-C, and 1-7-C except that a positive electrode mixture was obtained by mixing 94.1% by mass of lithium-cobalt composite oxide (LiCoO₂) as a positive electrode active material, 2.9% by mass of polyvinylidene fluoride (PVdF) having a melting point of 155° C. as a binder, and 3.0% by mass of carbon black as a conductive agent.

### Comparative Examples 1-15-C and 1-16-C

Laminate type batteries were obtained in the same manner as in Examples 1-5-A and 1-6-A except that a positive electrode mixture was obtained by mixing 94.1% by mass of lithium-cobalt composite oxide (LiCoO₂) as a positive electrode active material, 2.9% by mass of polyvinylidene fluoride (PVdF) having a melting point of 155° C. as a binder, and 3.0% by mass of carbon black as a conductive agent.

### Comparative Example 1-17-C

A Laminate type battery was obtained in the same manner as in Example 1-5-A except that a positive electrode mixture was obtained by mixing 93.5% by mass of lithium-cobalt composite oxide (LiCoO₂) as a positive electrode active material, 3.5% by mass of polyvinylidene fluoride (PVdF) having a melting point of 155° C. as a binder, and 3.0% by mass of carbon black as a conductive agent.

### Examples 2-1-A to 2-17-A

Laminate type batteries were obtained in the same manner as in Examples 1-1-A to 1-17-A except that polyvinylidene fluoride (PVdF) having a melting point of 166° C. was used as a binder.

### Comparative Examples 2-1-A to 2-11-A

Laminate type batteries were obtained in the same manner as in Comparative Examples 1-1-A to 1-11-A except that polyvinylidene fluoride (PVdF) having a melting point of 166° C. was used as a binder.

### Comparative Examples 2-1-B to 2-13-B

Laminate type batteries were obtained in the same manner as in Comparative Examples 1-1-B to 1-13-B except that polyvinylidene fluoride (PVdF) having a melting point of 166° C. was used as a binder.

### Comparative Examples 2-1-C to 2-17-C

Laminate type batteries were obtained in the same manner as in Comparative Examples 1-1-C to 1-17-C except that polyvinylidene fluoride (PVdF) having a melting point of 166° C. was used as a binder.

### Comparative Examples 3-1-A to 3-17-A

Laminate type batteries were obtained in the same manner as in Examples 1-1-A to 1-17-A except that polyvinylidene fluoride (PVdF) having a melting point of 172° C. was used as a binder.

### Comparative Examples 3-1-B to 3-11-B

Laminate type batteries were obtained in the same manner as in Comparative Examples 1-1-A to 1-11-A except that polyvinylidene fluoride (PVdF) having a melting point of 172° C. was used as a binder.

### Comparative Examples 3-1-C to 3-13-C

Laminate type batteries were obtained in the same manner as in Comparative Examples 1-1-B to 1-13-B except that polyvinylidene fluoride (PVdF) having a melting point of 172° C. was used as a binder.

### Comparative Examples 3-1-D to 3-17-D

Laminate type batteries were obtained in the same manner as in Comparative Examples 1-1-C to 1-17-C except that polyvinylidene fluoride (PVdF) having a melting point of 172° C. was used as a binder.

The batteries obtained as described above were subjected to the evaluation on high temperature storage swelling rate, nail penetration test, and positive electrode cracking as follows. The peeling off of the positive electrode active material layer was evaluated at the above-described battery fabricating stage.

### (High Temperature Storage Swelling Rate)

The battery was fully charged and then stored in a 60° C. environment for one month, and the change rate in swelling from before the storage was measured.

### (Nail Penetration Test)

The battery was fully charged so that the battery voltage was 4.40 V, then a φ2.5 mm nail was penetrated through the center of the battery at a piercing speed of 100 mm/sec in a 40° C. environment, and the presence or absence of thermal runaway was examined.

The batteries of Examples 1-1-A to 1-17-A which did not cause thermal runaway in the nail penetration test were further subjected to the following nail penetration test. Charge was performed in the same manner as above except that the batteries were newly prepared and the charging voltage was increased by 0.025 V and then the nail penetration test was performed again. The above-described procedure was repeated to determine the upper limit value of the charging voltage at which the battery did not cause thermal runaway by the nail penetration test.

### (Peeling Off of Positive Electrode Active Material Layer)

It was examined whether or not a part of the positive electrode active material layer on the positive electrode current collector was peeled off from the positive electrode current collector at the stage of slitting the positive electrode.

### (Positive Electrode Cracking)

The completed battery was disassembled, and it was examined whether or not a hole was formed in the positive electrode current collector at the innermost peripheral portion.

Tables 1A and 1B present the configurations and evaluation results of the laminate type batteries of Examples 1-1-A to 1-17-A, Comparative Examples 1-1-A to 1-11-A, Comparative Examples 1-1-B to 1-13-B, and Comparative Examples 1-1-C to 1-17-C.

TABLE 1A

| | | | | | | | | | 40° C. nail | | | |
|---|---|---|---|---|---|---|---|---|---|---|---|---|
| | | | | | | | | | penetration test | | | |
| | | | | | | | | | Presence | | | |
| | | | | | | | | | or | | | |
| | | | | | | | | | absence | | | |
| | | | | | | | | | of | | | |
| | | | | | | Geldike | | High | thermal | Upper | | |
| | | | Content | Content | | electrolyte | | temper- | runaway | limit | Peeling | Cracking |
| | | Melting | of | of | | layer | | ature | at | voltage | off of | of |
| | Kind of | point | binder | conduc- | Kind of | (containing | Element | storage | designed | without | positive | positive |
| | exterior | of | [% by | tive | sepa- | fluoro- | struc- | swelling | voltage | thermal | elec- | elec- |
| | member | binder | mass] | agent | rator | resin) | ture | rate | (4.40 V) | runaway | trode | trode |
| Example 1- | Laminate | 155 | 0.5 | 0.3 | Fluoro- | Absence | Foil- | 10 | Absence | 4.425 V | Absence | Absence |
| 1-A | film | | | | resin | | foil | | | | | |
| | | | | | coat | | structure | | | | | |
| | | | | | | | 1 | | | | | |
| Example 1- | | | | | | | Foil- | 10 | Absence | 4.425 V | Absence | Absence |
| 2-A | | | | | | | foil | | | | | |
| | | | | | | | structure | | | | | |
| | | | | | | | 2 | | | | | |
| Example 1- | | | | | Al₂O₃ | Absence | Foil- | 10 | Absence | 4.450 V | Absence | Absence |
| 3-A | | | | | coat | | foil | | | | | |
| | | | | | | | structure | | | | | |
| | | | | | | | 1 | | | | | |
| Example 1- | | | | | | | Foil- | 10 | Absence | 4.450 V | Absence | Absence |
| 4-A | | | | | | | foil | | | | | |
| | | | | | | | structure | | | | | |
| | | | | | | | 2 | | | | | |
| Example 1- | | | | | Without | Presence | Foil- | 9 | Absence | 4.400 V | Absence | Absence |
| 5-A | | | | | coating | | foil | | | | | |
| | | | | | | | structure | | | | | |
| | | | | | | | 1 | | | | | |
| Example 1- | | | | | | | Foil- | 9 | Absence | 4.400 V | Absence | Absence |
| 6-A | | | | | | | foil | | | | | |
| | | | | | | | structure | | | | | |
| | | | | | | | 1 | | | | | |
| Example 1- | | | 0.7 | 0.5 | Fluoro- | Absence | Foil- | 9 | Absence | 4.425 V | Absence | Absence |
| 7-A | | | | | resin | | foil | | | | | |
| | | | | | coat | | structure | | | | | |
| | | | | | | | 1 | | | | | |
| Example 1- | | | | | Al₂O₃ | Absence | Foil- | 9 | Absence | 4.475 V | Absence | Absence |
| 8-A | | | | | coat | | foil | | | | | |
| | | | | | | | structure | | | | | |
| | | | | | | | 1 | | | | | |
| Example 1- | | | | | Without | Presence | Foil- | 8 | Absence | 4.400 V | Absence | Absence |
| 9-A | | | | | coating | | foil | | | | | |
| | | | | | | | structure | | | | | |
| | | | | | | | 1 | | | | | |
| Example 1- | | | 1.4 | 1.5 | Fluoro- | Absence | Foil- | 8 | Absence | 4.425 V | Absence | Absence |
| 10-A | | | | | resin | | foil | | | | | |
| | | | | | coat | | structure | | | | | |
| | | | | | | | 1 | | | | | |
| Example 1- | | | | | Without | Presence | Foil- | 7 | Absence | 4.400 V | Absence | Absence |
| 11-A | | | | | coating | | foil | | | | | |
| | | | | | | | structure | | | | | |
| | | | | | | | 1 | | | | | |
| Example 1- | | | 2.8 | 2.8 | Fluoro- | Absence | Foil- | 6 | Absence | 4.425 V | Absence | Absence |
| 12-A | | | | | resin | | foil | | | | | |
| | | | | | coat | | structure | | | | | |
| | | | | | | | 1 | | | | | |
| Example 1- | | | | | | | Foil- | 6 | Absence | 4.425 V | Absence | Absence |
| 13-A | | | | | | | foil | | | | | |
| | | | | | | | structure | | | | | |
| | | | | | | | 2 | | | | | |
| Example 1- | | | | | Al₂O₃ | Absence | Foil- | 6 | Absence | 4.450 V | Absence | Absence |
| 14-A | | | | | coat | | foil | | | | | |
| | | | | | | | structure | | | | | |
| | | | | | | | 1 | | | | | |
| Example 1- | | | | | | | Foil- | 6 | Absence | 4.450 V | Absence | Absence |
| 15-A | | | | | | | foil | | | | | |
| | | | | | | | structure | | | | | |
| | | | | | | | 2 | | | | | |
| Example 1- | | | | | Without | Presence | Foil- | 5 | Absence | 4.400 V | Absence | Absence |
| 16-A | | | | | coating | | foil | | | | | |
| | | | | | | | structure | | | | | |
| | | | | | | | 1 | | | | | |
| Example 1- | | | | | | | Foil- | 5 | Absence | 4.400 V | Absence | Absence |
| 17-A | | | | | | | foil | | | | | |
| | | | | | | | structure | | | | | |
| | | | | | | | 2 | | | | | |
| Comparative | Laminate | 155 | 0.5 | 0.3 | Fluoro- | Absence | Normal | 10 | Presence | Less | Absence | Absence |
| Example | film | | | | resin | | structure | | | than | | |
| 1-1-A | | | | | coat | | 1 | | | 4.400 V | | |
| Comparative | | | | | Al₂O₃ | Absence | Normal | 10 | Presence | Less | Absence | Absence |
| Example | | | | | coat | | structure | | | than | | |
| 1-2-A | | | | | | | 1 | | | 4.400 V | | |
| Comparative | | | | | Without | Presence | Normal | 9 | Presence | Less | Absence | Absence |
| Example | | | | | coating | | structure | | | than | | |
| 1-3-A | | | | | | | 1 | | | 4.400 V | | |
| Comparative | | | 0.7 | 0.5 | Fluoro- | Absence | Normal | 9 | Presence | Less | Absence | Absence |
| Example | | | | | resin | | structure | | | than | | |
| 1-4-A | | | | | coat | | 1 | | | 4.400 V | | |
| Comparative | | | | | Al₂O₃ | Absence | Normal | 9 | Presence | Less | Absence | Absence |
| Example | | | | | coat | | structure | | | than | | |
| 1-5-A | | | | | | | 1 | | | 4.400 V | | |
| Comparative | | | | | Without | Presence | Normal | 8 | Presence | Less | Absence | Absence |
| Example | | | | | coating | | structure | | | than | | |
| 1-6-A | | | | | | | 1 | | | 4.400 V | | |
| Comparative | | | 1.4 | 1.5 | Fluoro- | Absence | Normal | 8 | Presence | Less | Absence | Absence |
| Example | | | | | resin | | structure | | | than | | |
| 1-7-A | | | | | coat | | 1 | | | 4.400 V | | |
| Comparative | | | | | Without | Presence | Normal | 7 | Presence | Less | Absence | Absence |
| Example | | | | | coating | | structure | | | than | | |
| 1-8-A | | | | | | | 1 | | | 4.400 V | | |
| Comparative | | | 2.8 | 2.8 | Fluoro- | Absence | Normal | 6 | Presence | Less | Absence | Absence |
| Example | | | | | resin | | structure | | | than | | |
| 1-9-A | | | | | coat | | 1 | | | 4.400 V | | |
| Comparative | | | | | Al₂O₃ | Absence | Normal | 6 | Presence | Less | Absence | Absence |
| Example | | | | | coat | | structure | | | than | | |
| 1-10-A | | | | | | | 1 | | | 4.400 V | | |
| Comparative | | | | | Without | Presence | Normal | 5 | Presence | Less | Absence | Absence |
| Example | | | | | coating | | structure | | | than | | |
| 1-11-A | | | | | | | 1 | | | 4.400 V | | |

TABLE 1B

| | | | | | | | | | 40° C. nail | | | |
|---|---|---|---|---|---|---|---|---|---|---|---|---|
| | | | | | | | | | penetration test | | | |
| | | | | | | | | | Presence | | | |
| | | | | | | | | | or | | | |
| | | | | | | | | | absence | | | |
| | | | | | | | | | of | | | |
| | | | | | | Gel-like | | High | thermal | Upper | | |
| | | | Content | Content | | electrolyte | | temper- | runaway | limit | Peeling | Cracking |
| | | Melting | of | of | | layer | | ature | at | voltage | off of | of |
| | Kind of | point | binder | conduc- | Kind of | (containing | | storage | designed | without | positive | positive |
| | exterior | of | [% by | tive | sepa- | fluoro- | Element | swelling | voltage | thermal | elec- | elec- |
| | member | binder | mass] | agent | rator | resin) | structure | rate | (4.40 V) | runaway | trode | trode |
| Comparative | Laminate | 155 | 0.5 | 0.3 | Without | Absence | Normal | 30 | Presence | Less | Absence | Absence |
| Example | film | | | | coating | | structure | | | than | | |
| 1-1-B | | | | | | | 1 | | | 4.400 V | | |
| Comparative | | | 0.7 | 0.5 | Without | Absence | Normal | 30 | Presence | Less | Absence | Absence |
| Example | | | | | coating | | structure | | | than | | |
| 1-2-B | | | | | | | 1 | | | 4.400 V | | |
| Comparative | | | 1.4 | 1.5 | Without | Absence | Normal | 30 | Presence | Less | Absence | Absence |
| Example | | | | | coating | | structure | | | than | | |
| 1-3-B | | | | | | | 1 | | | 4.400 V | | |
| Comparative | | | | | Fluoro- | Absence | Normal | Battery is not completed | | | Presence | Presence |
| Example | | | | | resin | | structure | | | | | |
| 1-4-B | | | | | coat | | 1 | | | | | |
| Comparative | | | 2.8 | 2.9 | Al₂O₃ | Absence | Normal | Battery is not completed | | | Presence | Presence |
| Example | | | | | coat | | structure | | | | | |
| 1-5-B | | | | | | | 1 | | | | | |
| Comparative | | | | | Without | Absence | Normal | Battery is not completed | | | Presence | Presence |
| Example | | | | | coating | | structure | | | | | |
| 1-6-B | | | | | | | 1 | | | | | |
| Comparative | | | | 3.0 | Fluoro- | Absence | Normal | 8 | Presence | Less | Presence | Absence |
| Example | | | | | resin | | structure | | | than | | |
| 1-7-B | | | | | coat | | 1 | | | 4.400 V | | |
| Comparative | | | | | Al₂O₃ | Absence | Normal | 8 | Presence | Less | Presence | Absence |
| Example | | | | | coat | | structure | | | than | | |
| 1-8-B | | | | | | | 1 | | | 4.400 V | | |
| Comparative | | | 2.9 | 3.0 | Fluoro- | Absence | Normal | Battery is not completed | | | Presence | Presence |
| Example | | | | | resin | | structure | | | | | |
| 1-9-B | | | | | coat | | 1 | | | | | |
| Comparative | | | | | Al₂O₃ | Absence | Normal | Battery is not completed | | | Presence | Presence |
| Example | | | | | coat | | structure | | | | | |
| 1-10-B | | | | | | | 1 | | | | | |
| Comparative | | | | | Without | Absence | Normal | Battery is not completed | | | Presence | Presence |
| Example | | | | | coating | | structure | | | | | |
| 1-11-B | | | | | | | 1 | | | | | |
| Comparative | | | | | Without | Presence | Normal | 7 | Presence | Less | Presence | Absence |
| Example | | | | | coating | | structure | | | than | | |
| 1-12-B | | | | | | | 1 | | | 4.400 V | | |
| Comparative | | | 3.5 | 3.0 | Without | Presence | Normal | Battery is not completed | | | Absence | Presence |
| Example | | | | | coating | | structure | | | | | |
| 1-13-B | | | | | | | 1 | | | | | |
| Comparative | Laminate | 155 | 0.5 | 0.3 | Without | Absence | Normal | 30 | Presence | Less | Absence | Absence |
| Example | film | | | | coating | | structure | | | than | | |
| 1-1-C | | | | | | | 1 | | | 4.400 V | | |
| Comparative | | | | | | | Normal | 30 | Presence | Less | Absence | Absence |
| Example | | | | | | | structure | | | than | | |
| 1-2-C | | | | | | | 2 | | | 4.400 V | | |
| Comparative | | | 0.7 | 0.5 | Without | Absence | Normal | 30 | Presence | Less | Absence | Absence |
| Example | | | | | coating | | structure | | | than | | |
| 1-3-C | | | | | | | 1 | | | 4.400 V | | |
| Comparative | | | 1.4 | 1.5 | Without | Absence | Normal | 20 | Presence | Less | Absence | Absence |
| Example | | | | | coating | | structure | | | than | | |
| 1-4-C | | | | | | | 1 | | | 4.400 V | | |
| Comparative | | | 2.8 | 2.9 | Fluoro- | Absence | Normal | Battery is not completed | | | Presence | Presence |
| Example | | | | | resin | | structure | | | | | |
| 1-5-C | | | | | coat | | 1 | | | | | |
| Comparative | | | | | Al₂O₃ | Absence | Normal | Battery is not completed | | | Presence | Presence |
| Example | | | | | coat | | structure | | | | | |
| 1-6-C | | | | | | | 1 | | | | | |
| Comparative | | | | | Without | Absence | Normal | Battery is not completed | | | Presence | Presence |
| Example | | | | | coating | | structure | | | | | |
| 1-7-C | | | | | | | 1 | | | | | |
| Comparative | | | | 3.0 | Fluoro- | Absence | Normal | 8 | Presence | Less | Presence | Absence |
| Example | | | | | resin | | structure | | | than | | |
| 1-8-C | | | | | coat | | 1 | | | 4.400 V | | |
| Comparative | | | | | | | Normal | 8 | Presence | Less | Presence | Absence |
| Example | | | | | | | structure | | | than | | |
| 1-9-C | | | | | | | 2 | | | 4 400 V | | |
| Comparative | | | | | Al₂O₃ | Absence | Normal | 8 | Presence | Less | Presence | Absence |
| Example | | | | | coat | | structure | | | than | | |
| 1-10-C | | | | | | | 1 | | | 4.400 V | | |
| Comparative | | | | | | | Normal | 8 | Presence | Less | Presence | Absence |
| Example | | | | | | | structure | | | than | | |
| 1-11-C | | | | | | | 2 | | | 4.400 V | | |
| Comparative | | | 2.9 | 3.0 | Fluoro- | Absence | Normal | Battery is not completed | | | Presence | Presence |
| Example | | | | | resin | | structure | | | | | |
| 1-13-C | | | | | coat | | 1 | | | | | |
| Comparative | | | | | Al₂O₃ | Absence | Normal | Battery is not completed | | | Presence | Presence |
| Example | | | | | coat | | structure | | | | | |
| 1-13-C | | | | | | | 1 | | | | | |
| Comparative | | | | | Without | Absence | Normal | Battery is not completed | | | Presence | Presence |
| Example | | | | | coating | | structure | | | | | |
| 1-14-C | | | | | | | 1 | | | | | |
| Comparative | | | | | Without | Presence | Normal | 7 | Presence | Less | Presence | Absence |
| Example | | | | | coating | | structure | | | than | | |
| 1-15-C | | | | | | | 1 | | | 4.400 V | | |
| Comparative | | | | | | | Normal | 7 | Presence | Less | Presence | Absence |
| Example | | | | | | | structure | | | than | | |
| 1-16-C | | | | | | | 1 | | | 4.400 V | | |

| | | | | | | | | |
|---|---|---|---|---|---|---|---|---|
| Comparative | 3.5 | 3.0 | Without | Presence | Normal | Battery is not completed | Absence | Presence |
| Example | | | coating | | structure | | | |
| 1-17-C | | | | | 1 | | | |

Tables 2A and 2B present the configurations and evaluation results of the laminate type batteries of Examples 2-1-A to 2-17-A, Comparative Examples 2-1-A to 2-11-A, Comparative Examples 2-1-B to 2-13-B, and Comparative Examples 2-1-C to 2-17-C.

TABLE 2A

| | | | | | | | | | Presence | | |
|---|---|---|---|---|---|---|---|---|---|---|---|
| | | | | | | | | | or absence | | |
| | | | | | | Gel-like | | | of thermal | | |
| | | | Content | | | electrolyte | | High | runaway | Peeling | Cracking |
| | | Melting | of | | | layer | | temperature | Nail | off of | of |
| | Kind of | point | binder | Content of | Kind of | (containing | | storage | penetration | positive | positive |
| | exterior | of | [% by | conductive | sepa- | fluoro- | Element | swelling | test | elec- | elec- |
| | member | binder | mass] | agent | rator | resin) | structure | rate | (40° C.) | trode | trode |
| Example 2- | Laminate | 166 | 0.5 | 0.3 | Fluoro- | Absence | Foil-foil | 10 | Absence | Absence | Absence |
| 1-A | film | | | | resin | | structure | | | | |
| | | | | | coat | | 1 | | | | |
| Example 2- | | | | | | | Foil-foil | 10 | Absence | Absence | Absence |
| 2-A | | | | | | | structure | | | | |
| | | | | | | | 2 | | | | |
| Example 2- | | | | | Al₂O₃ | Absence | Foil-foil | 10 | Absence | Absence | Absence |
| 3-A | | | | | coat | | structure | | | | |
| | | | | | | | 1 | | | | |
| Example 2- | | | | | | | Foil-foil | 10 | Absence | Absence | Absence |
| 4-A | | | | | | | structure | | | | |
| | | | | | | | 2 | | | | |
| Example 2- | | | | | Without | Presence | Foil-foil | 10 | Absence | Absence | Absence |
| 5-A | | | | | coating | | structure | | | | |
| | | | | | | | 1 | | | | |
| Example 2- | | | | | | | Foil-foil | 10 | Absence | Absence | Absence |
| 6-A | | | | | | | structure | | | | |
| | | | | | | | 2 | | | | |
| Example 2- | | | 0.7 | 0.5 | Fluoro- | Absence | Foil-foil | 10 | Absence | Absence | Absence |
| 7-A | | | | | resin | | structure | | | | |
| | | | | | coat | | 1 | | | | |
| Example 2- | | | | | Without | Absence | Foil-foil | 10 | Absence | Absence | Absence |
| 8-A | | | | | coating | | structure | | | | |
| | | | | | | | 1 | | | | |
| Example 2- | | | | | Al₂O₃ | Presence | Foil-foil | 10 | Absence | Absence | Absence |
| 9-A | | | | | coat | | structure | | | | |
| | | | | | | | 1 | | | | |
| Example 2- | | | 1.4 | 1.5 | Fluoro- | Absence | Foil-foil | 9 | Absence | Absence | Absence |
| 10-A | | | | | resin | | structure | | | | |
| | | | | | coat | | 1 | | | | |
| Example 2- | | | | | Without | Presence | Foil-foil | 9 | Absence | Absence | Absence |
| 11-A | | | | | coating | | structure | | | | |
| | | | | | | | 1 | | | | |
| Example 2- | | | | | Fluoro- | Absence | Foil-foil | 7 | Absence | Absence | Absence |
| 12-A | | | | | resin | | structure | | | | |
| | | | | | coat | | 1 | | | | |
| Example 2- | | | | | | | Foil-foil | 7 | Absence | Absence | Absence |
| 13-A | | | | | | | structure | | | | |
| | | | | | | | 2 | | | | |
| Example 2- | | | 2.8 | 2.8 | Al₂O₃ | Absence | Foil-foil | 6 | Absence | Absence | Absence |
| 14-A | | | | | coat | | structure | | | | |
| | | | | | | | 1 | | | | |
| Example 2- | | | | | | | Foil-foil | 6 | Absence | Absence | Absence |
| 15-A | | | | | | | structure | | | | |
| | | | | | | | 2 | | | | |
| Example 2- | | | | | Without | Presence | Foil-foil | 6 | Absence | Absence | Absence |
| 16-A | | | | | coating | | structure | | | | |
| | | | | | | | 1 | | | | |
| Example 2- | | | | | | | Foil-foil | 6 | Absence | Absence | Absence |
| 17-A | | | | | | | structure | | | | |
| | | | | | | | 2 | | | | |
| Comparative | Laminate | 166 | 0.5 | 0.3 | Fluoro- | Absence | Normal | 10 | Presence | Absence | Absence |
| Example | film | | | | resin | | structure | | | | |
| 2-1-A | | | | | coat | | 1 | | | | |
| Comparative | | | | | Al₂O₃ | Absence | Normal | 10 | Presence | Absence | Absence |
| Example | | | | | coat | | structure | | | | |
| 2-2-A | | | | | | | 1 | | | | |
| Comparative | | | | | Without | Presence | Normal | 10 | Presence | Absence | Absence |
| Example | | | | | coating | | structure | | | | |
| 2-3-A | | | | | | | 1 | | | | |
| Comparative | | | 0.7 | 0.5 | Fluoro- | Absence | Normal | 10 | Presence | Absence | Absence |
| Example | | | | | resin | | structure | | | | |
| 2-4-A | | | | | coat | | 1 | | | | |
| Comparative | | | | | Al₂O₃ | Absence | Normal | 10 | Presence | Absence | Absence |
| Example | | | | | coat | | structure | | | | |
| 2-5-A | | | | | | | 1 | | | | |
| Comparative | | | | | Without | Presence | Normal | 10 | Presence | Absence | Absence |
| Example | | | | | coating | | structure | | | | |
| 2-6-A | | | | | | | 1 | | | | |
| Comparative | | | 1.4 | 1.5 | Fluoro- | Absence | Normal | 9 | Presence | Absence | Absence |
| Example | | | | | resin | | structure | | | | |
| 2-7-A | | | | | coat | | 1 | | | | |
| Comparative | | | | | Without | Presence | Normal | 9 | Presence | Absence | Absence |
| Example | | | | | coating | | structure | | | | |
| 2-8-A | | | | | | | 1 | | | | |
| Comparative | | | 2.8 | 2.8 | Fluoro- | Absence | Normal | 7 | Presence | Absence | Absence |
| Example | | | | | resin | | structure | | | | |
| 2-9-A | | | | | coat | | 1 | | | | |
| Comparative | | | | | Al₂O₃ | Absence | Normal | 6 | Presence | Absence | Absence |
| Example | | | | | coat | | structure | | | | |
| 2-10-A | | | | | | | 1 | | | | |
| Comparative | | | | | Without | Presence | Normal | 6 | Presence | Absence | Absence |
| Example | | | | | coating | | structure | | | | |
| 2-11-A | | | | | | | 1 | | | | |

TABLE 2B

| | | | | | | | | | Presence | | |
|---|---|---|---|---|---|---|---|---|---|---|---|
| | | | | | | | | | or absence | | |
| | | | | | | | | | of thermal | | |
| | | | Content | | | Gel-like | | High | runaway | | |
| | | Melting | of | | | electrolyte | | temperature | Nail | Peeling | Cracking |
| | Kind of | point | binder | Content of | | layer | | storage | penetration | off of | of |
| | exterior | of | [% by | conductive | Kind of | (containing | Element | swelling | test | positive | positive |
| | member | binder | mass] | agent | separator | fluororesin) | structure | rate | (40° C.) | electrode | electrode |
| Comparative | Laminate | 166 | 0.5 | 0.3 | Without | Absence | Normal | 35 | Presence | Absence | Absence |
| Example | film | | | | coating | | structure | | | | |
| 2-1-B | | | | | | | 1 | | | | |
| Comparative | | | 0.7 | 0.5 | Without | Absence | Normal | 35 | Presence | Absence | Absence |
| Example | | | | | coating | | structure | | | | |
| 2-2-B | | | | | | | 1 | | | | |
| Comparative | | | 1.4 | 1.5 | Without | Absence | Normal | 32 | Presence | Absence | Absence |
| Example | | | | | coating | | structure | | | | |
| 2-3-B | | | | | | | 1 | | | | |
| Comparative | | | 2.8 | 2.9 | Fluororesin | Absence | Normal | Battery is not | | Presence | Presence |
| Example | | | | | coat | | structure | completed | | | |
| 2-4-B | | | | | | | 1 | | | | |
| Comparative | | | | | Al₂O₃ coat | Absence | Normal | Battery is not | | Presence | Presence |
| Example | | | | | | | structure | completed | | | |
| 2-5-B | | | | | | | 1 | | | | |
| Comparative | | | | | Without | Absence | Normal | Battery is not | | Presence | Presence |
| Example | | | | | coating | | structure | completed | | | |
| 2-6-B | | | | | | | 1 | | | | |
| Comparative | | | | 3.0 | Fluororesin | Absence | Normal | 10 | Presence | Presence | Absence |
| Example | | | | | coat | | structure | | | | |
| 2-7-B | | | | | | | 1 | | | | |
| Comparative | | | | | Al₂O₃ coat | Absence | Normal | 10 | Presence | Presence | Absence |
| Example | | | | | | | structure | | | | |
| 2-8-B | | | | | | | 1 | | | | |
| Comparative | | | 2.9 | 3.0 | Fluororesin | Absence | Normal | Battery is not | | Presence | Presence |
| Example | | | | | coat | | structure | completed | | | |
| 2-9-B | | | | | | | 1 | | | | |
| Comparative | | | | | Al₂O₃ coat | Absence | Normal | Battery is not | | Presence | Presence |
| Example | | | | | | | structure | completed | | | |
| 2-10-B | | | | | | | 1 | | | | |
| Comparative | | | | | Without | Absence | Normal | Battery is not | | Presence | Presence |
| Example | | | | | coating | | structure | completed | | | |
| 2-11-B | | | | | | | 1 | | | | |
| Comparative | | | | | Without | Presence | Normal | 9 | Presence | Presence | Absence |
| Example | | | | | coating | | structure | | | | |
| 2-12-B | | | | | | | 1 | | | | |
| Comparative | | | 3.5 | 3.0 | Without | Presence | Normal | Battery is not | | Absence | Presence |
| Example | | | | | coating | | structure | completed | | | |
| 2-13-B | | | | | | | 1 | | | | |
| Comparative | Laminate | 166 | 0.5 | 0.3 | Without | Absence | Foil-foil | 35 | Presence | Absence | Absence |
| Example | film | | | | coating | | structure | | | | |
| 2-1-C | | | | | | | 1 | | | | |
| Comparative | | | | | | | Foil-foil | 35 | Presence | Absence | Absence |
| Example | | | | | | | structure | | | | |
| 2-2-C | | | | | | | 2 | | | | |
| Comparative | | | 0.7 | 0.5 | Without | Absence | Foil-foil | 35 | Presence | Absence | Absence |
| Example | | | | | coating | | structure | | | | |
| 2-3-C | | | | | | | 1 | | | | |
| Comparative | | | 1.4 | 1.5 | Without | Absence | Foil-foil | 32 | Presence | Absence | Absence |
| Example | | | | | coating | | structure | | | | |
| 2-4-C | | | | | | | 1 | | | | |
| Comparative | | | 2.8 | 2.9 | Fluororesin | Absence | Foil-foil | Battery is not | | Presence | Presence |
| Example | | | | | coat | | structure | completed | | | |
| 2-5-C | | | | | | | 1 | | | | |
| Comparative | | | | | Al₂O₃ coat | Absence | Foil-foil | Battery is not | | Presence | Presence |
| Example | | | | | | | structure | completed | | | |
| 2-6-C | | | | | | | 1 | | | | |
| Comparative | | | | | Without | Absence | Foil-foil | Battery is not | | Presence | Presence |
| Example | | | | | coating | | structure | completed | | | |
| 2-7-C | | | | | | | 1 | | | | |
| Comparative | | | | 3.0 | Fluororesin | Absence | Foil-toil | 10 | Presence | Presence | Absence |
| Example | | | | | coat | | structure | | | | |
| 2-8-C | | | | | | | 1 | | | | |
| Comparative | | | | | | | Foil-foil | 10 | Presence | Presence | Absence |
| Example | | | | | | | structure | | | | |
| 2-9-C | | | | | | | 2 | | | | |
| Comparative | | | | | Al₂O₃ coat | Absence | Foil-foil | 10 | Presence | Presence | Absence |
| Example | | | | | | | structure | | | | |
| 2-10-C | | | | | | | 1 | | | | |
| Comparative | | | | | | | Foil-foil | 10 | Presence | Presence | Absence |
| Example | | | | | | | structure | | | | |
| 2-11-C | | | | | | | 2 | | | | |
| Comparative | | | 2.9 | 3.0 | Fluororesin | Absence | Foil-foil | Battery is not | | Presence | Presence |
| Example | | | | | coat | | structure | completed | | | |
| 2-12-C | | | | | | | 1 | | | | |
| Comparative | | | | | Al₂O₃ coat | Absence | Foil-foil | Battery is not | | Presence | Presence |
| Example | | | | | | | structure | completed | | | |
| 2-13-C | | | | | | | 1 | | | | |
| Comparative | | | | | Without | Absence | Foil-foil | Battery is not | | Presence | Presence |
| Example | | | | | coating | | structure | completed | | | |
| 2-14-C | | | | | | | 1 | | | | |
| Comparative | | | | | Without | Presence | Foil-foil | 9 | Presence | Presence | Absence |
| Example | | | | | coating | | structure | | | | |
| 2-15-C | | | | | | | 1 | | | | |
| Comparative | | | | | | | Foil-foil | 9 | Presence | Presence | Absence |
| Example | | | | | | | structure | | | | |
| 2-16-C | | | | | | | 2 | | | | |

| | | | | | | | | |
|---|---|---|---|---|---|---|---|---|
| Comparative | 3.5 | 3.0 | Without | Presence | Foil-foil | Battery is not | Absence | Presence |
| Example | | | coating | | structure | completed | | |
| 2-17-C | | | | | 1 | | | |

Tables 3A and 3B present the configurations and evaluation results of the laminate type batteries of Comparative Examples 3-1-A to 3-17-A, Comparative Examples 3-1-B to 3-11-B, Comparative Examples 3-1-C to 3-13-C, Comparative Examples 3-1-D to 3-17-D.

TABLE 3A

| | | | | | | | | | Presence | | |
|---|---|---|---|---|---|---|---|---|---|---|---|
| | | | | | | | | | or absence | | |
| | | | | | | | | | of thermal | | |
| | | | Content | | | Gel-like | | High | runaway | | |
| | | Melting | of | | | electrolyte | | temperature | Nail | Peeling | Cracking |
| | Kind of | point | binder | Content of | | layer | | storage | penetration | off of | of |
| | exterior | of | [% by | conductive | Kind of | (containing | Element | swelling | test | positive | positive |
| | member | binder | mass] | agent | separator | fluororesin) | structure | rate | (40° C.) | electrode | electrode |
| Comparative | Laminate | 172 | 0.5 | 0.3 | Fluororesin | Absence | Foil-foil | 25 | Presence | Absence | Absence |
| Example | film | | | | coat | | structure | | | | |
| 3-1-A | | | | | | | 1 | | | | |
| Comparative | | | | | | | Foil-foil | 25 | Presence | Absence | Absence |
| Example | | | | | | | structure | | | | |
| 3-2-A | | | | | | | 2 | | | | |
| Comparative | | | | | Al₂O₃ coat | Absence | Foil-foil | 25 | Presence | Absence | Absence |
| Example | | | | | | | structure | | | | |
| 3-3-A | | | | | | | 1 | | | | |
| Comparative | | | | | | | Foil-foil | 25 | Presence | Absence | Absence |
| Example | | | | | | | structure | | | | |
| 3-4-A | | | | | | | 2 | | | | |
| Comparative | | | | | Without | Presence | Foil-foil | 24 | Presence | Absence | Absence |
| Example | | | | | coating | | structure | | | | |
| 3-5-A | | | | | | | 1 | | | | |
| Comparative | | | | | | | Foil-foil | 24 | Presence | Absence | Absence |
| Example | | | | | | | structure | | | | |
| 3-6-A | | | | | | | 2 | | | | |
| Comparative | | | | | Fluororesin | Absence | Foil-foil | 25 | Presence | Absence | Absence |
| Example | | | | | coat | | structure | | | | |
| 3-7-A | | | | | | | 1 | | | | |
| Comparative | | | 0.7 | 0.5 | Al₂O₃ coat | Absence | Foil-foil | 25 | Presence | Absence | Absence |
| Example | | | | | | | structure | | | | |
| 3-8-A | | | | | | | 1 | | | | |
| Comparative | | | | | | Presence | Foil-foil | 23 | Presence | Absence | Absence |
| Example | | | | | | | structure | | | | |
| 3-9-A | | | | | | | 1 | | | | |
| Comparative | | | 1.4 | 1.5 | Fluororesin | Absence | Foil-foil | 23 | Presence | Absence | Absence |
| Example | | | | | coat | | structure | | | | |
| 3-10-A | | | | | | | 1 | | | | |
| Comparative | | | | | Without | Presence | Foil-foil | 22 | Presence | Absence | Absence |
| Example | | | | | coating | | structure | | | | |
| 3-11-A | | | | | | | 1 | | | | |
| Comparative | | | | | Fluororesin | Absence | Foil-foil | 22 | Presence | Absence | Absence |
| Example | | | | | coat | | structure | | | | |
| 3-12-A | | | | | | | 1 | | | | |
| Comparative | | | | | | | Foil-foil | 22 | Presence | Absence | Absence |
| Example | | | | | | | structure | | | | |
| 3-13-A | | | | | | | 2 | | | | |
| Comparative | | | 2.8 | 2.8 | Al₂O₃ coat | Absence | Foil-foil | 22 | Presence | Absence | Absence |
| Example | | | | | | | structure | | | | |
| 3-14-A | | | | | | | 1 | | | | |
| Comparative | | | | | | | Foil-foil | 22 | Presence | Absence | Absence |
| Example | | | | | | | structure | | | | |
| 3-15-A | | | | | | | 2 | | | | |
| Comparative | | | | | Without | Presence | Foil-foil | 20 | Presence | Absence | Absence |
| Example | | | | | coating | | structure | | | | |
| 3-16-A | | | | | | | 1 | | | | |
| Comparative | | | | | | | Foil-foil | 20 | Presence | Absence | Absence |
| Example | | | | | | | structure | | | | |
| 3-17-A | | | | | | | 2 | | | | |
| Comparative | | | | | Fluororesin | Absence | Normal | 25 | Presence | Absence | Absence |
| Example | | | | | coat | | structure | | | | |
| 3-1-B | | | | | | | 1 | | | | |
| Comparative | Laminate | 172 | 0.5 | 0.3 | Al₂O₃ coat | Absence | Normal | 25 | Presence | Absence | Absence |
| Example | film | | | | | | structure | | | | |
| 3-2-B | | | | | | | 1 | | | | |
| Comparative | | | | | Without | Presence | Normal | 24 | Presence | Absence | Absence |
| Example | | | | | coating | | structure | | | | |
| 3-3-B | | | | | | | 1 | | | | |
| Comparative | | | 0.7 | 0.5 | Fluororesin | Absence | Normal | 25 | Presence | Absence | Absence |
| Example | | | | | coat | | structure | | | | |
| 3-4-B | | | | | | | 1 | | | | |
| Comparative | | | | | Al₂O₃ coat | Absence | Normal | 25 | Presence | Absence | Absence |
| Example | | | | | | | structure | | | | |
| 3-5-B | | | | | | | 1 | | | | |
| Comparative | | | | | Without | Presence | Normal | 23 | Presence | Absence | Absence |
| Example | | | | | coating | | structure | | | | |
| 3-6-B | | | | | | | 1 | | | | |
| Comparative | | | 1.4 | 1.5 | Fluororesin | Absence | Normal | 23 | Presence | Absence | Absence |
| Example | | | | | coat | | structure | | | | |
| 3-7-B | | | | | | | 1 | | | | |
| Comparative | | | | | Without | Presence | Normal | 22 | Presence | Absence | Absence |
| Example | | | | | coating | | structure | | | | |
| 3-8-B | | | | | | | 1 | | | | |
| Comparative | | | 2.8 | 2.8 | Fluororesin | Absence | Normal | 22 | Presence | Absence | Absence |
| Example | | | | | coat | | structure | | | | |
| 3-9-B | | | | | | | 1 | | | | |
| Comparative | | | | | Al₂O₃ coat | Absence | Normal | 22 | Presence | Absence | Absence |
| Example | | | | | | | structure | | | | |
| 3-10-B | | | | | | | 1 | | | | |
| Comparative | | | | | Without | Presence | Normal | 20 | Presence | Absence | Absence |
| Example | | | | | coating | | structure | | | | |
| 3-11-B | | | | | | | 1 | | | | |

TABLE 3B

| | | | | | | | | | Presence | | |
|---|---|---|---|---|---|---|---|---|---|---|---|
| | | | | | | | | | or absence | | |
| | | | | | | | | | of thermal | | |
| | | | Content | | | Gel-like | | High | runaway | | |
| | | Melting | of | | | electrolyte | | temperature | Nail | Peeling | Cracking |
| | Kind of | point | binder | Content of | | layer | | storage | penetration | off of | of |
| | exterior | of | [% by | conductive | Kind of | (containing | Element | swelling | test | positive | positive |
| | member | binder | mass] | agent | separator | fluororesin) | structure | rate | (40° C.) | electrode | electrode |
| Comparative | Laminate | 172 | 0.5 | 0.3 | Without | Absence | Normal | 30 | Presence | Absence | Absence |
| Example | film | | | | coating | | structure | | | | |
| 3-1-C | | | | | | | 1 | | | | |
| Comparative | | | 0.7 | 0.5 | Without | Absence | Normal | 41 | Presence | Absence | Absence |
| Example | | | | | coating | | structure | | | | |
| 3-2-C | | | | | | | 1 | | | | |
| Comparative | | | 1.4 | 1.5 | Without | Absence | Normal | 39 | Presence | Absence | Absence |
| Example | | | | | coating | | structure | | | | |
| 3-3-C | | | | | | | 1 | | | | |
| Comparative | | | 2.8 | 2.9 | Fluororesin | Absence | Normal | Battery is not | | Presence | Presence |
| Example | | | | | coat | | structure | completed | | | |
| 3-4-C | | | | | | | 1 | | | | |
| Comparative | | | | | Al₂O₃ coat | Absence | Normal | Battery is not | | Presence | Presence |
| Example | | | | | | | structure | completed | | | |
| 3-5-C | | | | | | | 1 | | | | |
| Comparative | | | | | Without | Absence | Normal | Battery is not | | Presence | Presence |
| Example | | | | | coating | | structure | completed | | | |
| 3-6-C | | | | | | | 1 | | | | |
| Comparative | | | | 3.0 | Fluororesin | Absence | Normal | 35 | Presence | Presence | Absence |
| Example | | | | | coat | | structure | | | | |
| 3-7-C | | | | | | | 1 | | | | |
| Comparative | | | | | Al₂O₃ coat | Absence | Normal | 32 | Presence | Presence | Absence |
| Example | | | | | | | structure | | | | |
| 3-8-C | | | | | | | 1 | | | | |
| Comparative | | | | | Fluororesin | Absence | Normal | Battery is not | | Presence | Presence |
| Example | | | | | coat | | structure | completed | | | |
| 3-9-C | | | | | | | 1 | | | | |
| Comparative | | | 2.9 | 3.0 | Al₂O₃ coat | Absence | Normal | Battery is not | | Presence | Presence |
| Example | | | | | | | structure | completed | | | |
| 3-10-C | | | | | | | 1 | | | | |
| Comparative | | | | | Without | Absence | Normal | Battery is not | | Presence | Presence |
| Example | | | | | coating | | structure | completed | | | |
| 3-11-C | | | | | | | 1 | | | | |
| Comparative | | | | | Without | Presence | Normal | 29 | Presence | Presence | Absence |
| Example | | | | | coating | | structure | | | | |
| 3-12-C | | | | | | | 1 | | | | |
| Comparative | | | 3.5 | 3.0 | Without | Presence | Normal | Battery is not | | Absence | Presence |
| Example | | | | | coating | | structure | completed | | | |
| 3-13-C | | | | | | | 1 | | | | |
| Comparative | Laminate | 172 | 0.5 | 0.3 | Without | Absence | Foil-foil | 30 | Presence | Absence | Absence |
| Example | film | | | | coating | | structure | | | | |
| 3-1-D | | | | | | | 1 | | | | |
| Comparative | | | | | | | Foil-foil | 30 | Presence | Absence | Absence |
| Example | | | | | | | structure | | | | |
| 3-2-D | | | | | | | 2 | | | | |
| Comparative | | | 0.7 | 0.5 | Without | Absence | Foil-foil | 41 | Presence | Absence | Absence |
| Example | | | | | coating | | structure | | | | |
| 3-3-D | | | | | | | 1 | | | | |
| Comparative | | | 1.4 | 1.5 | Without | Absence | Foil-foil | 39 | Presence | Absence | Absence |
| Example | | | | | coating | | structure | | | | |
| 3-4-D | | | | | | | 1 | | | | |
| Comparative | | | 2.8 | 2.9 | Fluororesin | Absence | Foil-foil | Battery is not | | Presence | Presence |
| Example | | | | | coat | | structure | completed | | | |
| 3-5-D | | | | | | | 1 | | | | |
| Comparative | | | | | Al₂O₃ coat | Absence | Foil-foil | Battery is not | | Presence | Presence |
| Example | | | | | | | structure | completed | | | |
| 3-6-D | | | | | | | 1 | | | | |
| Comparative | | | | | Without | Absence | Foil-foil | Battery is not | | Presence | Presence |
| Example | | | | | coating | | structure | completed | | | |
| 3-7-D | | | | | | | 1 | | | | |
| Comparative | | | | 3.0 | Fluororesin | Absence | Foil-foil | 35 | Presence | Presence | Absence |
| Example | | | | | coat | | structure | | | | |
| 3-8-D | | | | | | | 1 | | | | |
| Comparative | | | | | | | Foil-foil | 35 | Presence | Presence | Absence |
| Example | | | | | | | structure | | | | |
| 3-9-D | | | | | | | 2 | | | | |
| Comparative | | | | | Al₂O₃ coat | Absence | Foil-foil | 32 | Presence | Presence | Absence |
| Example | | | | | | | structure | | | | |
| 3-10-D | | | | | | | 1 | | | | |
| Comparative | | | | | | | Foil-foil | 32 | Presence | Presence | Absence |
| Example | | | | | | | structure | | | | |
| 3-11-D | | | | | | | 2 | | | | |
| Comparative | | | 2.9 | 3.0 | Fluororesin | Absence | Foil-foil | Battery is not | | Presence | Presence |
| Example | | | | | coat | | structure | completed | | | |
| 3-12-D | | | | | | | 1 | | | | |
| Comparative | | | | | Al₂O₃ coat | Absence | Foil-foil | Battery is not | | Presence | Presence |
| Example | | | | | | | structure | completed | | | |
| 3-13-D | | | | | | | 1 | | | | |
| Comparative | | | | | Without | Absence | Foil-foil | Battery is not | | Presence | Presence |
| Example | | | | | coating | | structure | completed | | | |
| 3-14-D | | | | | | | 1 | | | | |
| Comparative | | | | | Without | Presence | Foil-foil | 29 | Presence | Presence | Absence |
| Example | | | | | coating | | structure | | | | |
| 3-15-D | | | | | | | 1 | | | | |
| Comparative | | | | | | | Foil-foil | 29 | Presence | Presence | Absence |
| Example | | | | | | | structure | | | | |
| 3-16-D | | | | | | | 2 | | | | |

| | | | | | | | | |
|---|---|---|---|---|---|---|---|---|
| Comparative | 3.5 | 3.0 | Without | Presence | Foil-foil | Battery is not | Absence | Presence |
| Example | | | coating | | structure | completed | | |
| 3-17-D | | | | | 1 | | | |

The following can be seen from Tables 1A to 3B.

When the evaluation results in Examples 1-1-A to 1-17-A, Comparative Examples 1-1-A to 1-11-A, Examples 2-1-A to 2-17-A, Comparative Examples 2-1-A to 2-11-A, Comparative Examples 3-1-A to 3-17-A, and Comparative Examples 3-1-B to 3-11-B are compared with one another, the high temperature storage swelling rate is 10% or less in the laminate type batteries in which the melting point of the positive electrode binder is 166° C. or less. In a case in which the outer peripheral portion of the wound electrode body has the foil-foil structure 1 or foil-foil structure 2 in which the positive electrode current collector exposed portion and the negative electrode current collector exposed portion face each other with the separator interposed therebetween, the laminate type batteries do not cause thermal runaway in the 40° C. nail penetration test. In contrast, the high temperature storage swelling rate is 20% or more to be significantly high in laminate type batteries in which the melting point of the positive electrode binder is 172° C. The laminate type batteries cause thermal runaway in the 40° C. nail penetration test even when the outer peripheral portion of the wound electrode body has the foil-foil structure 1 or foil-foil structure 2 in which the positive electrode current collector exposed portion and the negative electrode current collecting exposed portion face each other with the separator interposed therebetween.

Hence, from the viewpoint of achieving both high temperature storage swelling and 40° C. nail penetration safety, it can be seen that the melting point of the positive electrode binder is preferably 166° C. or less and the outer peripheral portion of the wound electrode body desirably has the foil-foil structure 1 or foil-foil structure 2 in which the positive electrode current collector and the negative electrode current collector face each other with the separator interposed therebetween.

When the evaluation results in Examples 1-1-A to 1-17-A, Comparative Examples 1-1-A to 1-11-A, Comparative Examples 1-1-B to 1-13-B, and Comparative Examples 1-1-C to 1-17-C are compared with one another, in a case in which the melting point of the positive electrode binder is 155° C., the high temperature storage swelling rate is 10% or less, thermal runaway is not caused in the 40° C. nail penetration test, the positive electrode cracking does not occur at the time of assembly, and peeling off of the positive electrode active material layer is also not observed when slitting the positive electrode in laminate type batteries in which (a) the content of the binder in the positive electrode active material layer is 0.5% by mass or more and 2.8% by mass or less, (b) the content of the conductive agent is 0.3% by mass or more and 2.8% by mass or less, (c) a fluororesin-containing layer (fluorine resin coat layer, gel-like electrolyte layer) or metal oxide grains or both of these exist between the positive electrode and the separator, and (d) the outer peripheral portion of the wound electrode body has a structure in which the positive electrode current collector and the negative electrode current collector face each other with the separator interposed therebetween. In contrast, in laminate type batteries which do not have any of the configurations (a), (b), (c), and (d), defects are caused in at least one of high temperature storage swelling rate, 40° C. nail penetration test, positive electrode cracking, or peeling of positive electrode active material layer or the batteries are not completed. The battery is not completed because the positive electrode has been broken at the time of winding.

The discussion on the evaluation results of the laminate type batteries of Examples 2-1-A to 2-17-A, Comparative Examples 2-1-A to 2-11-A, Comparative Examples 2-1-B to 2-13-B, and Comparative Examples 2-1-C to 2-17-C can be said to be similar to the discussion on the evaluation results of Examples 1-1-A to 1-17-A, Comparative Examples 1-1-A to 1-11-A, Comparative Examples 1-1-B to 1-13-B, and Comparative Examples 1-1-C to 1-17-C.

From the evaluation results of the laminate type batteries of Comparative Examples 3-1-A to 3-17-A, Comparative Examples 3-1-B to 3-11-B, Comparative Examples 3-1-C to 3-13-C, and Comparative Examples 3-1-D to 3-17-D, in a case in which the melting point of the positive electrode binder is 172° C., defects are caused in at least one of high temperature storage swelling rate, 40° C. nail penetration test, positive electrode cracking, or peeling of positive electrode active material layer or the batteries are not completed regardless of whether or not the laminate type batteries have all of the configurations (a), (b), (c), and (d).

From the evaluation results on the nail penetration test (evaluation results on the upper limit voltage) of Examples 1-1-A to 1-17-A, it can be seen that the configuration in which an intermediate layer containing inorganic grains is provided between the electrode and the separator is more preferable to the configuration in which an intermediate layer containing a fluororesin is provided between the electrode and the separator from the viewpoint of further improving the safety.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A battery comprising:
a positive electrode that includes a positive electrode current collector and a positive electrode active material layer provided on the positive electrode current collector and has a positive electrode current collector exposed portion at which the positive electrode current collector is exposed;
a negative electrode that includes a negative electrode current collector and a negative electrode active material layer provided on the negative electrode current collector and has a negative electrode current collector exposed portion at which the negative electrode current collector is exposed;
a separator provided between the positive electrode and the negative electrode; and
an intermediate layer that is provided between the separator and at least one of the positive electrode and the negative electrode and includes at least one of a fluororesin and a grain,
wherein
the positive electrode, the negative electrode, and the separator are stacked, and the positive electrode current collector exposed portion and the negative electrode current collector exposed portion face each other with the separator interposed therebetween,
the positive electrode active material layer including a fluorine-based binder having a melting point of 166° C. or less and a conductive agent,
a content of the fluorine-based binder in the positive electrode active material layer is from 0.5% by mass to 2.8% by mass, and
a content of the conductive agent in the positive electrode active material layer is from 0.3% by mass to 2.8% by mass.

2. The battery according to claim 1, wherein the positive electrode current collector exposed portion and the negative electrode current collector exposed portion are respectively provided at outer peripheral side end portions of the positive electrode and the negative electrode that are wound.

3. The battery according to claim 1, wherein
the positive electrode current collector exposed portion is provided at an inner peripheral side end portion and an outer peripheral side end portion of the positive electrode that is wound, and
the negative electrode current collector exposed portion is provided at an inner peripheral side end portion and an outer peripheral side end portion of the negative electrode that is wound.

4. The battery according claim 1, wherein the fluorine-based binder includes polyvinylidene fluoride.

5. The battery according claim 2, wherein the fluorine-based binder includes polyvinylidene fluoride.

6. The battery according claim 3, wherein the fluorine-based binder includes polyvinylidene fluoride.

7. The battery according claim 1, wherein the fluororesin is configured to retain an electrolytic solution.

8. The battery according claim 2, wherein the fluororesin is configured to retain an electrolytic solution.

9. The battery according claim 3, wherein the fluororesin is configured to retain an electrolytic solution.

10. The battery according claim 4, wherein the fluororesin is configured to retain an electrolytic solution.

11. The battery according to claim 7, wherein the intermediate layer includes a gel-like electrolyte layer.

12. The battery according to claim 1, wherein the grain includes an inorganic grain.

13. The battery according to claim 12, wherein the inorganic grain includes a metal oxide.

14. The battery according to claim 13, wherein the metal oxide includes at least one of aluminum oxide, boehmite, magnesium oxide, titanium oxide, zirconium oxide, silicon oxide, yttrium oxide, and zinc oxide.

15. The battery according to claim 1, wherein the battery further comprises a film-like exterior material configured to accommodate the positive electrode, the negative electrode, the separator, and the intermediate layer, and
the positive electrode, the negative electrode, the separator, and the intermediate layer constitute a flat wound electrode body.

16. The battery according to claim 15, wherein
the flat wound electrode body has a facing portion at which the positive electrode current collector exposed portion and the negative electrode current collector exposed portion face each other with the separator interposed therebetween, and
the facing portion is provided over at least one flat surface of the flat wound electrode body.
